(19) United States
(12) Patent Application Publication
(10) Pub. No.: US 2026/0106908 A1
(43) Pub. Date: Apr. 16, 2026

(54) SYSTEM AND METHOD FOR HEADLESS COMMUNICATIONS ARCHIVAL FOR MULTICHANNEL COMMUNICATIONS ACROSS DEVICES

(71) Applicant: Movius Interactive Corportion, Alpharetta, GA (US)

(72) Inventors: Manoj Rajshekar, Duluth, GA (US); Amyn Sheriff, Alpharetta, GA (US); Chethan Visweswar, Alpharetta, GA (US); Paul Rubenstein, Roswell, GA (US)

(73) Assignee: Movius Interactive Corporation, Alpharetta, GA (US)

(21) Appl. No.: 19/419,530

(22) Filed: Dec. 15, 2025

Related U.S. Application Data
(63) Continuation-in-part of application No. 18/924,959, filed on Oct. 23, 2024.
(60) Provisional application No. 63/684,833, filed on Aug. 19, 2024.

(51) Int. Cl. H04L 65/403

(52) U.S. Cl. CPC H04L 65/403

(57) ABSTRACT

The various embodiments of the present invention presented herein, as well as other variations, are directed towards systems and method for enabling multichannel communications across a variety of devices in a single group conversation.

### BACKGROUND

“Didn't you get my message?” That question always seems to invoke a sinking feeling inside. The feeling of “oh no, I have somehow failed in the world of messaging.” How is it possible in such a connected world filled with such a wide variety of messaging technology and capabilities that it is ever necessary to ask that question? The answer to this question is easy, we are not really in a “connected world”. We claim to be living in a “connected world” but really, it is just a world of connections. As such, we live in a world of disjointed and fractured communications in which party A can direct communications toward party B over a variety of paths using a variety of technologies but to receive the communication, party B has to be accessible over any of the paths using any of the technologies at all times. And thus the “didn't you get my message” cycle continues.

The free world thrives on the provision of variety. Variety is the field leveler in a competitive world. And in the field of telecommunications, this world has plenty of variety. One would be hard pressed to find a person these days that does not carry a mobile phone. Even the homeless people standing at their most popular intersections can be seen talking on their mobile telephones. IOS or Android based mobile and smart telephones are available from a variety of manufactures such as APPLE, SAMSUNG, LG, MOTOROLA, NOKIA, VIVO, REALME, HUAWEI, ONEPLUS, GOOGLE PIXEL, and others. These smart telephones can be utilized or provisioned from a variety of service providers such as T-MOBILE, VERIZON WIRELESS, XFINITY MOBILE, US MOBILE, CRICKET WIRELESS, MINT MOBILE and others. But the variety does not stop there.

While this plethora of mobile and smart telephones can be serviced by any one or more of the various of service providers, the smart telephones may employ one or more of a huge variety of communication channels or techniques. These communication channels can include (a) carrier-based or app-based calling applications, texting/SMS applications such as WHATSAPP, MESSENGER, TELEGRAM, SIGNAL, MESSAGE+, GROUPME, KIK and DUST as non-limiting examples, (b) social media based communication channels such as FACEBOOK, INSTAGRAM, WECHAT, TIKTOK, and LINKED IN, as non-limiting examples, (c) video conferencing applications such as ZOOM, MICROSOFT TEAMS, RING CENTRAL, GOTO MEETING, WEBEX, and GOOGLE MEET as non-limiting examples, and third-party web apps running on desktops, mobile apps, etc.

As those skilled in the art will conclude, with the vast number of smart devices, the number of service providers, the number of communication channels combined with different communication needs and habits of the users, it is easy to see why the “didn't you get my message?” question is so frequently presented.

What is needed in the art is a solution that can take this communication bowl of spaghetti and somehow tie it all together into a single package in which users can easily communicate with each other over this ever growing and expanding network of ions. The embodiments of the present invention as presented herein, along with equivalents thereof provide a solution to this need in the art.

Further, it will be appreciated that many regulated enterprises and agencies allow their end users or employees to utilize their own devices, such as their own mobile telephones and smart phones within the scope of their employment. Operating in this manner is referred to as a Bring Your Own Device (or “BYOD”) policy.

BYOD, which may also be referred to as bring your own technology (BYOT), bring your own phone (BYOP), and bring your own personal computer (BYOPC)) are practices that involve allowing someone to use their personally owned device, rather than being required to use a device that is provided by, owned by, controlled by and monitored by the company or enterprise that the person is a part of. Collectively, these practices can be referred to as BYOX, where X can be a device (D), a phone (P), a personal computer PC, etc.

Within the workplace or an enterprise, BYOX refers to a policy of permitting employees to bring personally owned devices (laptops, tablets, smartphones, etc.) to work, and to use those devices to access privileged company information and applications. This phenomenon is sometimes called IT consumerization in the industry.

The proliferation of devices such as tablets and smartphones, now used by many people in their daily lives, has led to a number of companies allowing employees to bring their own devices to work. One of the justifications is that because the employees are familiar with their own devices, there may be a productivity gain and cost savings. However, use of personal devices also gives rise to security concerns. While the BYOX policy provides the beneficial ability for employees to work at any time from anywhere and on any device, the companies must deploy security measures to prevent information ending up in the wrong hands. According to an IDG survey, more than half of 1,600 senior IT security and technology purchase decision-makers reported serious violations of personal mobile device use.

BYOX security relates strongly to the end node problem where the same device is used to access both sensitive and risky networks and services. As such, BYOX devices may result in data breaches. As an example, if an employee uses a BYOX to access the company network and then loses that device, untrusted parties could retrieve any unsecured data from the device. Another problem arises when an employee ceases to work with the company. Because the device belongs to the user, the company applications and data may still be present on the device. This is further exasperated by the fact that the employee may eventually sell the device and forget to delete the sensitive information prior to delivering the device. In addition, family members or friends may share devices such as tablets. In such cases, sensitive data may be accidentally deleted or shared.

In addition, there are privacy concerns with BYOX. For instance, an enterprise that is monitoring the usage of personal devices must ensure that they monitor only activities that are work-related or access company data or information and not to monitor personal activities such as social networking, searching, etc.

When an enterprise implements a BYOX policy, it must also consider how it will ensure that the devices connecting to the organization's network infrastructure to access sensitive information will be protected from malware. Traditionally if the device was owned by the organization, the organization controls what purposes the device may be used for or what public sites may be accessed from the device. An organization can typically expect users to use their own devices to connect to the Internet from private or public locations. The users could be susceptible from attacks originating from untethered browsing or could potentially access less secure or compromised sites that may contain harmful material and compromise the security of the device.

Software developers and device manufacturers constantly release security patches to counteract threats from malware. Enterprises with BYOX policies must have systems and processes to apply patches protecting systems against known vulnerabilities of the devices that users may use. Ideally, such departments should have agile systems that can quickly adopt the support necessary for new devices. Supporting a broad range of devices obviously carries a large administrative overhead. An enterprise without a BYOX policy has the benefit of selecting a small number of devices to support. On the other hand, an enterprise with a BYOX policy could also limit the number of supported devices, though this could defeat the objective of allowing users the freedom to choose their preferred devices.

Several technologies have been created to address BYOX security concerns, including mobile device management (MDM) and containerization and app virtualization.

Another issue related to BYOX policies is the ownership of the BYOX phone number or other communication methods (email, calls, texts, etc). The issue becomes apparent when employees leave the company and take their device, along with the number or address connected with the device. For instance, customers calling a number that has been associated with a BYOX device will then potentially be calling competitors, which can lead to loss of business for enterprises that employ the use of BYOX.

It is more difficult for the firm to manage and control the consumer technologies and make sure they serve the needs of the business.[45] Firms need an efficient inventory management system that keeps track of the devices employees are using, where the device is located, whether it is being used, and what software it is equipped with.[45] If sensitive, classified, or criminal data lands on a U.S. government employee's device, the device is subject to confiscation.[46]

Another important issue with BYOD is of scalability and capability. Many enterprises lack proper network infrastructure to handle the large traffic generated when employees use different devices at the same time. Employees use mobile devices as their primary devices and they demand a certain level performance. With today's smartphones, which can access webpages as quickly as most PCs do and may use radio and voice at high bandwidths, may impose an increasing demand on an enterprises WLAN infrastructure.

Reimbursement for the cost and use of a personal device is yet another issue that enterprises must address in a BYOX environment. For instance, will the enterprise reimburse the employee for their use of their personal device for work. Similarly, the enterprise and employees can have trouble navigating the tax implications of reimbursement and the best practices surrounding reimbursement for personal device use.

Therefore, there is a need in the art for a solution to these problems, risks, vulnerabilities, etc. that can be inherent in a BYOX environment.

### BRIEF SUMMARY

The various embodiments of the present invention presented herein, as well as other variations, are directed towards systems and method for enabling multichannel communications across a variety of devices in a single group conversation.

One embodiment includes a system to enable multichannel communication across a variety of devices in a single group conversation. The system utilizes or is based on the use of a unified communication platform (“UCP”). The UCP includes a plurality of interfaces, wherein each of the plurality of interfaces are communicatively coupled to the unified communication platform and are communicatively couplable to one or more user devices. In operation, the unified communications platform includes a processing system that is configured to perform various tasks or operations. For instance, in establishing a group conversation, the UCP receives a communication request through a first interface from a first user device. The communication request identifies one or more participating user devices for a communication session and a unique ID for the first user device. The unique ID may be associated with a user, an end user device or a position within an enterprise or company. The unique ID at least identifies a preferred communication channel for the first user device and may be associated with a list of preferred communications channels such as FACEBOOK, WHATSAPP, ZOOM, MICROSOFT TEAMS, LINKEDIN, etc.

The UCP then operates to identify a preferred channel for each of the participating user devices that are identified in the request. At this point, the UCP can then establish a connection between the first user device and each of the participating user devices to commence a group communications session.

Once the communications session is established, the UCP receives one or more conversation elements from the first user device, or any of the participating user devices. The UCP operates to convert the received conversation element to a format compatible with each of the one or more participating user devices and then delivers the converted conversation elements to the participating user devices. As such, users from diverse channels are converged into a single group communications session, using their platform, application or communication technique that they prefer.

In some embodiments, the UCP can receive a channel change request from the first user device or any of the one or more participating user devices during the group communications session. Without disrupting the group communications session, the UCP can then begin converting the received conversation elements in accordance with the channel change request. For instance, if a user device switches from FACEBOOK MESSENGER to LINKEDIN or ZOOM, etc., the group communication session continues uninterrupted and the user device simply changes the channel type over which the communications are delivered. As a non-limiting example, the user device may switch from a text messaging application to a application this is more amenable for file transfers.

In some embodiments, the preferred channel for each of the user devices is based on a preferred application that is being utilized to communicate by each of the user devices. In such embodiments, the unified communications platform receives a channel change request from the first user device or any of the one or more participating user devices during the group communications session, wherein the channel change request is provided by the requesting user switching to a different application. Similarly, without disrupting the group communications session, the UCP begins converting the received conversation elements in accordance with the format required for the different application.

In some embodiments, the system includes an interface to an archive for storing information. In such embodiments, the UCP stores each of the communications elements into the archive as a communications history. The communications elements that are stored into the archive as a communications history may be text messages, files, voice calls, and video calls, as non-limiting examples. Further, the UCP may also provide access to any of the user devices to access and review its respective communications history.

In some embodiments, the system may include interfaces such as a PBX interface for integrating telephone calls; a social media messaging interface for integrating social media communications; an enterprise interface for integrating video conferences; and a customer relationship management (“CRM”) interface for integrating CRM systems.

The various embodiments may utilize a unique ID that is associated with any available communication channel. This enables a single unique ID, that may be associated with a user, a user device, or a position in a company or organization, to utilize multiple channels all tied to the same unique ID.

### BRIEF DESCRIPTION OF THE SEVERAL VIEWS OF THE DRAWING

FIG. 1 is a block diagram illustrating an exemplary functional structure for enabling conversations between users that are using different channels.

FIG. 2 is a block diagram illustrating a more specific example of the use case illustrated in FIG. 1 illustrating the provision of a group conversation between multiple users that may be utilizing different channels that are integrated into the UCP.

FIG. 3 is a block diagram illustrating multichannel integration as multichannel authentication to authenticate for different workflows and communication.

FIG. 4 is a functional diagram illustrating the telecommunications integration goal of various embodiments of the present invention.

FIG. 5 is a functional block diagram illustrating the operation of an exemplary communications platform interacting with a carrier partner providing certain integrated communication services.

FIG. 6 is a flow diagram illustrating a first communication exchange example based on an exemplary architecture such as that illustrated in FIG. 5 as a non-limiting example.

FIG. 7 is a flow diagram illustrating a communication exchange example based on an exemplary architecture such as that illustrated in FIG. 5.

FIG. 8 is a flow diagram illustrating another communication exchange example based on an exemplary architecture such as that illustrated in FIG. 5.

FIG. 9 is a sky of clouds illustrating the overall operation of an embodiment of an exemplary communications platform.

FIG. 10 is a block diagram illustrating the basic operations of an exemplary embodiment providing NCMC across devices.

FIG. 11 is a block diagram illustrating scenario 1—providing out-of-band disclaimers for a message that is initially provided from a CL subscriber.

FIG. 12 is a block diagram illustrating scenario 2, providing out-of-band disclaimers for a message that is initially provided from a non-CL subscriber.

FIG. 13 is a block diagram illustrating scenario 3—providing out-of-band disclaimers for a message that is initially provided from Paul (a CL subscriber) and involves John (another CL subscriber).

FIG. 14 is a block diagram illustrating scenario 4—providing in-band disclaimers for a message that is initially provided from Paul (a CL subscriber).

FIG. 15 is a functional block diagram of the components of an exemplary embodiment of system or sub-system operating as a controller or processor that could be used in various embodiments of the disclosure for controlling aspects of the various embodiments.

### DETAILED DESCRIPTION OF VARIOUS EMBODIMENTS

The various embodiments of the present invention presented herein, as well as other variations, are directed towards providing a solution that enables calls and messages to be captured on standard SIM based lines for regulated enterprises and agencies. In such embodiments, the end users do not need to install any applications or use a BYOX device. More specifically, the various embodiments include the ability to provide a Native Capture of Multichannel Communication (NCMC) across devices, which operates to capture voice calls and messaging from the telco core network for all its approved subscribers for:
Network Interception. Network interception refers to telco network operators intercepting applicable calls at strategic points in their network, such as mobile switching centers (MSCs) or signaling transfer points (STPs);
Signaling Interception. Signaling interception is when a platform, such as a Unified Communication Platform (“UCP”), collects network signaling data or information, such as call setup and teardown messages, SMS and MMS messages, and other network signaling information;
Voice Call Monitoring. In voice call monitoring, a platform, such as the UCP, uses the signaling data to identify and record voice calls in real-time, storing the audio or streaming it to external systems as files in a secure database or SIPREC (SIP Recording) to a customer's store (SIPREC is an open standard protocol that allows for the recording of audio and video calls over the internet and which is based on the Session Initiation Protocol (SIP), which is used to initiate, maintain, and end communication sessions);
Messaging Interception. Message interception refers to a platform, such as the UCP, collecting SMS and MMS messages, including text, images, and other multimedia content;
Data Collection and Storage. Data collection and storage involve collecting data which is then processed, stored, and indexed in a secure encrypted database, allowing for efficient searching, retrieval, and analysis;
Data Analysis and Insights. The objective of data analysis and insights is to obtain the processed data and analyze the data using various tools and techniques, such as speech recognition, natural language processing, and machine learning, to extract insights and patterns;
Lawful Access. Lawful access refers to the UCP meeting CALEA requirements by providing law enforcement agencies with access to the collected data, following legal procedures and protocols, to support criminal investigations and national security efforts, however, in some embodiments there is no need to provide CALEA support in that every call and message may actually route through the telco network and be available to law enforcement from the carrier;
Network Performance Monitoring. Network performance monitoring involves a platform, such as the UCP, analyzing the collected data to monitor and improve network performance, detect fraud, and optimize resource allocation;
Customer Behavior Analysis. Applying customer behavior analysis involves using the insights and patterns extracted from the data to improve customer experience, personalize services, and develop targeted marketing campaigns;
Data Protection and Privacy. In the provision of data protection and privacy, a platform, such as the UCP, may operate to ensure the privacy and security of subscriber data, adhering to regulations and standards, such as GDPR and CCPA, and implementing robust encryption and access controls;

The various embodiments of the present invention may be implemented upon or in conjunction with the Unified Communication Platform (UCP) described in U.S. application Ser. No. 18/809,032, which is incorporated above by reference. The UCP enables mobile devices and platforms (as well as applications or programs running thereon) to communicatively interface with each other over various communication channels and provides for authentication of the users involved in the communication session.

The word “exemplary” is used herein to mean “serving as an example, instance, or illustration.” Any aspect described herein as “exemplary” is not necessarily to be construed as preferred or advantageous over other aspects.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “telecommunications device,” “communication device,” “wireless device,” “wireless telephone,” “wireless communication device” and “wireless handset” are used interchangeably. With the advent of third generation (“3G”), fourth generation (“4G”), fifth generation (“5G”), and beyond wireless technology, greater bandwidth availability has enabled more portable computing devices with a greater variety of wireless capabilities. Therefore, a telecommunications device (“TD”) may include a cellular telephone, a pager, a PDA, a smartphone, a navigation device, a tablet personal computer (“PC”), a hand-held computer with a wireless connection or link, a watch, a chip embedded within an individual and integrated within the brain, nervous system and muscular system, etc.

In this description, various operations, functions, aspects, features, capabilities, etc. maybe described as systems, components, modules, servers, etc., but it should be appreciated that the various operations, functions, aspects, features, capabilities can be implemented in any form of hardware, code, software, firmware, and combinations thereof.

In this description, the terms “call” and “communication,” in their noun forms, envision any data transmission routed across a network from one device to another including, but not limited to, a voice transmission, a text message, a video message, a page, a data transmission, etc., and including actually content or information as well as control messages to set up and tear down the communication channel.

Turning now to the figures in which like elements are represented by similar labels, various embodiments, as well as aspects, features and characteristics of the embodiments are presented in more detail.

The heart of today's telecommunication industry is found in wireless-based networks serving as the integration of mobile and wireless devices into the historical public switched network technology (“PSTN”). However, the use of the PSTN to reach into homes and businesses has been greatly replaced using wireless technology, while the backbone of the PSTN is still in use. But wireless and mobile networks are quite varied and exist in a variety of telecommunications technologies, such as 3G, 4G, 5G, LTE, GSM, etc., as well as other wireless technology including WIFI, BLUETOOTH, INFRARED, BROADCAST RADIO, MICROWAVE, and even satellite technologies. Each of these technologies have similarities and differences.

A goal or object of the various embodiments of the present invention is to provide a technique, technology, solution, methodology, etc. that enables the widest array of end user devices to communicate with other end user devices and provide compatibility no matter what protocol or technology is being utilized. Throughout this description, the term end user device is used to refer to any element that can originate and/or receive a communication. Thus, as non-limiting examples, end user devices (sometimes referred to herein as EUDs) may be mobile telephones, smart phones, tablets, note pads, IPADS, notebook computers, desktop computers, personal data assistants, POTS devices, smart watches, applications running on any of the afore mentioned devices such as messaging applications, video conference applications, voice messaging applications, financial transaction devices, point of sale terminals, CRM applications, social media applications, PBXs, archival applications, enterprise collaboration applications, healthcare integrations, etc. As such, a EUD may be an application running on a mobile telephone, or it may be a hardware enablement of a mobile telephone, etc.

### Introduction and Background

The Unified Communication Platform (herein after referred to as “UCP”) is a revolutionary communication hub that integrates multiple communication channels into a single, user-friendly interface. The UCP also operates as a secure interoperable communications capture and archival system for enterprises. The UCP enables seamless communication across various platforms and channels, including voice and video calls, messaging apps, social media, and more.

In general, the various embodiments of the UCP may include at least some of the following features: Omnichannel Interface; Omni Device support; Unified Inbox; Smart Routing; Enhanced Security; AI-Powered Chatbots; Analytics and Insights; and Scalability and Flexibility. Each of these features are described herein and/or related applications in greater detail.

As the name implies, the Omnichannel Interface allows communication to be transmitted and/or received over any available channel. A user may have a favorite application that is desired to be used for sending and receiving messages. The user may wish to spend any communication engagement time within that favorite application without having to switch to different applications to see if the user has received a message from a party using that channel. The Omnichannel Interface allows the user to send messages to another through any channel but still enable the user to utilize his or her favorite application. Likewise, the Omnichannel Interface allows the user to receive messages from other parties that transmitted the messages using a different application from the user's favorite application. As such, the UCP combines multiple communication channels such as: voice and video calls; SMS and MMS; social media platforms (FACEBOOK, INSTAGRAM, LINKEDIN, TINDER, etc.); messaging apps (WHATSAPP, SIGNAL, TELEGRAM, etc.); enterprise collaboration channels such as MS TEAMS, SLACK, ZOOM; CRM systems such as SALESFORECE, SERVICENO, ZENDESK; email; and video conferencing such that messages received over one channel can be directed to a destination over a different channel.

Similarly, the various embodiments may provide Omni Device support. The Omnichannel interfaces would operate on or within the UCP and can interact with heterogeneous devices such as SmartPhones, Tablets, Connected Laptops, Desktops, Smart TVs, Smart Kiosks, iOT devices which would have computer, network connectivity such as wireless protocols, SIM, eSIM, and/or Satellite connectivity.

In some situations, a user may have and utilize multiple applications. For instance, the user may utilize LINKEDIN to communicate with potential clients or to conduct business development but use WHATSAPP to communicate confidential information with existing clients. It may be desirable for the user to be able to access all such communications in a single place, which is referred to in the various embodiments as a Unified Inbox. Utilizing the Unified Inbox, the user can receive and manage all messages, calls, and notifications in a single inbox, eliminating the need to switch between apps.

To implement some of the afore mentioned features, the UCP implements Smart Routing. This feature operates to automatically route incoming messages and calls to or through the most suitable channel, ensuring efficient communication. Thus, if a user identifies a particular application as being the application of choice, the UCP will direct communications over a channel for that application. Further, the user may specify suitable channels for different types of messages. For instance, voice calls may be directed to one application while SMS messages may be directed to another. Further, messages from contacts in a certain class or category may be directed to an application that is different for contacts in a different class or category. It will be appreciated that may factors may be utilized for filtering and directing messages, such as time of day, subject matter, day of the week, location of recipient, etc.

In implementing the capabilities of the UCP, privacy and security of the users are not compromised. The UCP provides Enhanced Security by implementing end-to-end encryption, two-factor authentication, and granular access controls to safeguard user data.

Utilization of technology, such as the UCP, is highly dependent upon the usability of the technology. Users have grown to expect intuitive user interfaces without the need for complicated user manuals, training and added IT support. The embodiments of the UCP may be equipped with AI-Powered Chatbots. The AI-driven chatbots enable automated customer support, lead generation, and personalized engagement for users utilizing the UCP.

The various embodiments of the UCP can dynamically analyze and provide feedback to users to improve the usability of the system. As such, the UCP obtains Analytics and Insights. Real-time analytics and actionable insights are used to optimize communication strategies and user engagement.

The various embodiments of the UCP provide Scalability and Flexibility. The various embodiments operate to support businesses of all sizes, with customizable workflows and integrations with existing systems.

Advantageously, the various embodiments of the UCP operate to provide multiple benefits. For instance, one such benefit is the provision of streamlined communication. The various embodiments of the UCP may provide streamlined communication by simplifying communication through the consolidation of multiple, or even all possible channels in some embodiments, into a single platform that can direct communication in accordance with user desires and/or a variety of parameters. In essence, the UCP takes multiple disjointed channels and unifies them together such that users can send and receive communications over their preferred channels.

Another benefit provided by embodiments of the UCP is an increase in productivity. The UCP reduces, and in some cases eliminates, switching costs (meaning the time lost for users to switch between various applications and channels) and enables users to respond more quickly and efficiently.

The various embodiments of the UCP provide an enhanced customer experience. This is accomplished by providing a unified and personalized experience across all communication channels. Further, the various embodiments of the UCP offer improved security by providing an environment in which robust security features can be implemented and thereby protect user data and provide a high-level of trust.

The various embodiments of the UCP can be utilized by businesses as well as individuals. For business users, the UCP advantageously enhances customer engagement, streamlines communication, and boosts productivity. For individuals, the UCP advantageously simplifies personal and professional communication, and enables the enjoyment of a unified experience across all channels.

Various embodiments of the UCP also provide compliance and regulation. The embodiments include the capability to collect and record all communications between representatives of an enterprise and its customers and provides one-to-one or group conversation between individuals with common interests for compliance purposes. By harnessing the power of the UCP, users can experience a seamless and efficient communication experience, unlocking new possibilities for connection and collaboration.

Further understanding of the structure, operation, features and advantages of the UCP are illustrated by various use cases.

Use Case—Conversations Between Users that Come from Different Channels, Wherein the Channels are Integrated into the UCP.

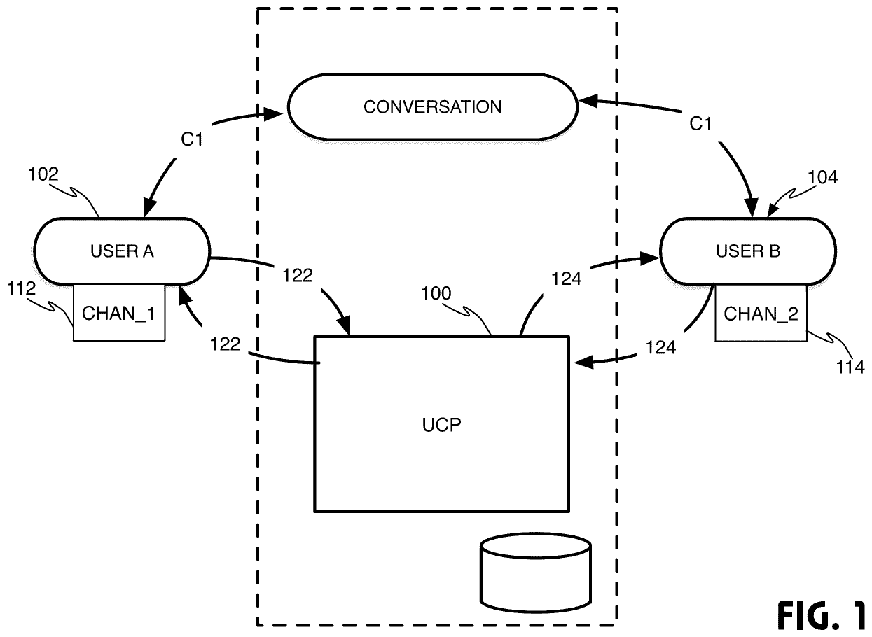

FIG. 1 is a block diagram illustrating an exemplary functional structure for enabling conversations between users that are using different channels. The illustration in FIG. 1 is that of User A 102 initiating a new communication connection with User B 104 or continuing to use an existing conversation or connection which is referred to as Conversation C1.

In the illustrated example, User A 102 is utilizing channel type CHAN_1 112 as its communication channel to establish or provide a communication to User B 104. User B 104 is illustrated as using channel type CHAN_2 114. User A 102 could be using any of a variety of channel types but for purposes of illustration, User A 102 is shown at utilizing CHAN_1 112. User A 102 authenticates using CHAN_1 112 authentication protocols and establishes a connection 122 with the UCP 100. The authentication is accomplished using security tokens needed to identify and authenticate in the UCP 100.

Upon User A 102 successfully authenticating with the UCP 100, the UCP 100 can receive a connection request over connection 122. The connection request identifies a request to connect with User B 104. The UCP 100 then can initiate a connection with User B 104 over connection 124.

In response to receiving a communication request, User B authenticates using CHAN_2 114 authentication protocols and communicates of the connection 124 with the UCP 100. The authentication is accomplished using security tokens needed to identify and authenticate in the UCP 100.

Once User B 104 is authenticated, User B 104 joins conversation C1 using CHAN_2 114 and User A 102 joins conversation C1 using CHAN_1 112. As a more particular non-limiting example, in one case, User A 102, the initiator, may be the owner of a business and User B 104 could be an Enterprise user communicating customer service, or both could be enterprise users or both could be consumers.

Communication could be established as part of conversation C1, where messages could be text messages, supporting any digital multi-media content, and conversations could traverse into other modalities beyond text to voice or video. It will be appreciated that while the illustrated example was for a one-to-one communication, the various embodiments can handle many-to-one, one-to-many, and many-to-many as well.

Use Case—Group Conversations Between Users that Come from Different Channels, Wherein the Channels are Integrated into the UCP.

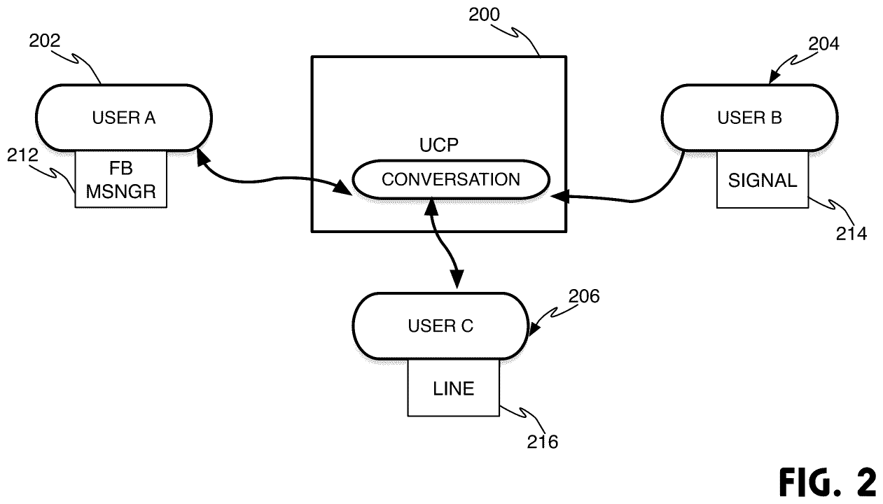

FIG. 2 is a block diagram illustrating a more specific example of the use case illustrated in FIG. 1 illustrating the provision of a group conversation between multiple users that may be utilizing different channels that are integrated into the UCP.

For example, User A 202, User B 204 and User C 206 are illustrated as entering into a group conversation and utilizing different channel identities and channel handles from each other. Users having different channel identities and channel handles would join after authenticating with the UCP 200 and establishing a common group conversation. User A 202 is illustrated as authenticating using FACEBOOK MESSENGER authentication protocols 212 and establishes a connection with the UCP 200 using security tokens needed to identify and authenticate in the UCP 200 and to initiate an existing or new conversation. User B 204 authenticates using SIGNAL authentication protocols and establishes a connection with the UCP 200 using security tokens needed to identify and authenticate in the UCP 200. Once authenticated, User B 204 would join the conversation using a SIGNAL channel 214. User C 206 authenticates using LINE channel 216 authentication protocols and establishes a connection with the UCP 200 using security tokens needed to identify and authenticate in the UCP 200. Once authenticated, User C 206 would join the conversation using a Line channel 216. The communication would be established as part of the conversation where messages could be text messages, supporting any digital multi-media content, and conversations could traverse into other modalities beyond text to voice or video.

### Use Case—Multichannel Integration as Multichannel Authentication (MCA) to Authenticate for Different Workflows and Communication.

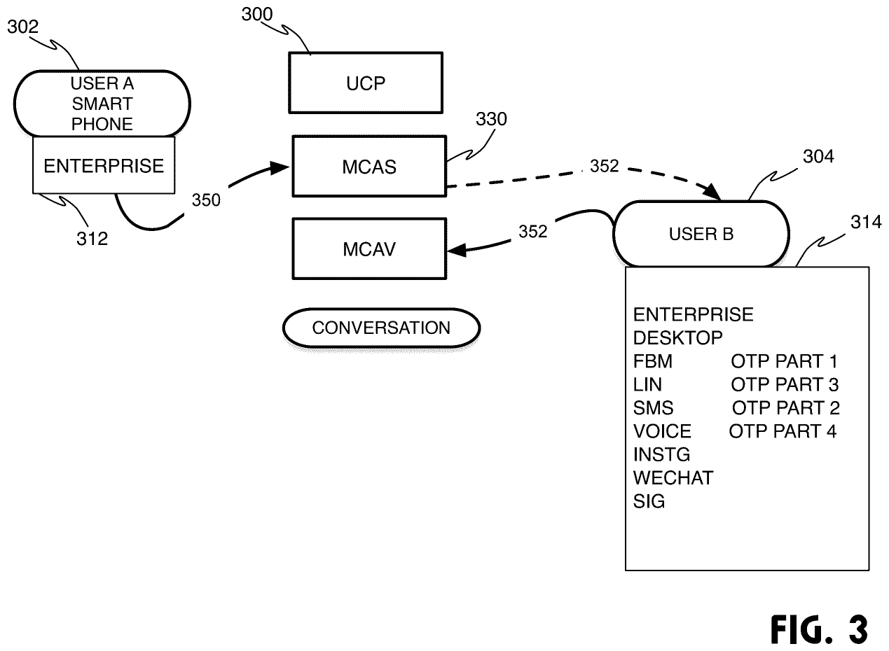

FIG. 3 is a block diagram illustrating multichannel integration as multichannel authentication to authenticate for different workflows and communication. In the illustrated example, User A 302 belongs to an enterprise 312 and connects to the UCP 300 using one of the approved identities and integrated channels. To start a conversation with User B 304, User A 302 needs to authenticate and get approval from User B 304 for a specific workflow. As illustrated, User B 304 has multiple handles 314 (i.e. FB MESSENGER, INSTAGRAM, WECHAT, SIGNAL, LINKEDIN, SMS, Voice). Each of the handles are registered into the UCP 300. Thus, User A 302 sends a one-time password (OTP) 350 to the multichannel authentication splitter (MCAS) 330.

The importance of safe, user-friendly user authentication has become increasingly important for organizations of all sizes. While password-based authentication has long been a standard method, evolving threats and user friction have led to the consideration of alternative options. One notable solution that has gained prominence and which is utilized in various embodiments is one-time password (OTP) authentication.

An OTP is a dynamically generated set of numbers or letters designed to grant users one-time access to an application. Unlike traditional passwords, OTPs aren't static and change every time a user attempts to log in. An OTP is sometimes called a one-time PIN, one-time passcode, or one-time authorization code (OTAC).

OTPs can be sent to users via SMS, email, messaging services like WhatsApp, or mobile push notifications. Alternatively, OTP generators such as hardware keys and mobile authenticator apps can be used for authentication. One-time passcodes are often a secondary factor in a multi-factor authentication (MFA) flow.

There are two primary types of OTPs, each offering unique advantages and use cases: Time-based OTP (TOTP) and HMAC-based OTP (HOTP). OTP generation algorithms generally receive two inputs that are used to generate OTP codes:

(1) A seed—this static secret key is shared between the token and the server. It is created when a new account is established on the authentication server.

(2) A moving factor—this is a component that changes every time a new OTP is requested. The main difference between HOTP and TOTP is how the moving factor is generated.

The “H” in HOTP stands for Hash-Based Message Authentication Code (HMAC). Thus, HOTP stands for HMAC-Based One-Time Password. In HOTP, the moving factor is a counter incremented every time a new OTP is requested. This counter is stored on both the token and the server. The counter on the token increments by one when a new OTP is requested. The counter on the server increments by one when an OTP is successfully validated.

HOTP tends to be user-friendly since it doesn't increment until the user requests a new OTP, making it suitable for scenarios where time synchronization might be a challenge. This means the user has ample time to enter the OTP. However, this also makes HOTP more susceptible to brute-force attacks.

TOTP stands for Time-based One-time Password. TOTP's moving factor is based on time rather than incremental counters. The OTP changes after a specified period of time called a timestep, which is usually between 30 to 90 seconds.

TOTP is generally more secure than HOTP and tough to crack with brute force attacks. However, the user must input the passcode before it refreshes, which introduces the possibility of time drift. To cope with this, the authenticating server must make it easy for users to input a new OTP if the previous one expires.

Returning to FIG. 3, the OTP 350 sent by User A 302 can be in the following format:

| | | |
|---|---|---|
| TEXT/VOICE | SENDING CHANNEL | RECEIVING CHANNEL |

For example, the OTP 350 could be structured as follows:

| | | |
|---|---|---|
| MESSAGE | ENTERPRISE | FB MESSENGER |

User s 302 action of sending the OTP 350 causes a trigger of the multi-channel authenticator splitter (MCAS) 330 which then operates to split the OTP across different channels for User B 304 and send the split OTP over the channels 352. Upon reception by User B 304, User B 304 would need to assemble the complete OTP from the sequence of channels which User A would have specified.

User A 302 could split for a specific sequence of channels, allow the MCAS 330 randomizer to choose the sequence of channels, or even choose a subset of channels for authentication purposes. For User B 304 to validate and authenticate, the response 352 from User B 304 would reach the mobile authenticator validator (MCAV) 340 to validate against the request from MCAS 330.

To complete authentication the MCAS 330 and the MCAV 340 can run at the edge (device of the user) or reside on the server and interface with interfaces such as mobile apps, web apps, etc.

Use Case—Video Communication Modality from Different Native Communication Channels.

Embodiments of the UCP provide for interoperable group conversations with video calling. More particularly, the UCP enables users from diverse social media channels to converge into a single, cohesive group conversation. This innovative feature allows users to connect with others across different platforms, fostering a collaborative and inclusive environment.

For example, the various embodiments may include multi-platform convergence. With this capability, users from various social media channels, such as FACEBOOK, INSTAGRAM, LINKEDIN, WHATSAPP, etc., can join into a single group conversation. Thus, a user of FACEBOOK can seamlessly be involved in a group conversation with others on FACEBOOK or any of the other listed communication applications or others.

Another advantage is that the various embodiments may exchange messages, files, and media with others in the group, regardless of their original platform. Further, with respect to video calling, the various embodiments may initiate high-quality video calls with individuals or groups, transcending platform boundaries. In addition, the various embodiments may include real-time translation. The automatic language translation enables users to communicate effectively, despite language barriers.

As an example, suppose a marketing team consists of members from different departments with each member using their preferred social media platform. Thus, the team may be attempting to communicate from various platforms. With UCP and the unified profile identifier, the team members can create a combined group conversation, incorporating team members from FACEBOOK, LINKEDIN, WHATSAPP, etc. The team members can share files, discuss projects, and initiate video calls, all within a single interface, regardless of their native platform.

### Use Case—Switching Specific Conversations for a User Across Different Channels Through UCP.

Various embodiments of the UCP may provide dynamic channel switching for a registered user in UCP. Within the UCP, users in a group conversation can effortlessly switch between different channels they are registered on without disrupting the conversation. This feature enables users to adapt their communication channel to suit their needs, preferences, or circumstances, all in real-time.

In operation, User A's user profile attributes in the UCP with have all the registered channels (inclusive of email, phone number, physical coordinates as non-limiting examples) as attributes for the user. During a group conversation, as the UCP aggregates all the communication happening with a user, the user can decide to switch to a specific channel for various workflow purposes. Advantageously, this aspect of various embodiments of the UCP gives capabilities at the user level for User A to perform the following function or receive the following service:
Channel Selection: During a group conversation, users can select (or an app that is being used may select the channel that is best suited for the communication type) a new channel from their registered platforms (e.g., from FACEBOOK to WHATSAPP or from LINKEDIN to SIGNAL, etc.);
Seamless Handover: The intelligent routing system of the UCP ensures a seamless transition, maintaining the conversation's continuity and context;
Channel-Specific Features: Users can leverage the unique features of their chosen channel, such as end-to-end encryption on SIGNAL or file sharing on WHATSAPP as non-limiting examples; and
Real-time Updates: The conversation updates in real-time, reflecting the user's new channel selection, ensuring all participants are aware of the change.

Advantageously, this aspect of the UCP provides flexibility, contextual communication, enhanced privacy, streamlined communication, and automatic update with other channels in conversation. As for flexibility, the users are able to adapt their communication channel to suit their needs, preferences, or circumstances—all in real-time without interrupting the conversation. For contextual communication, the users are able to leverage the strengths of different channels to enhance the conversation. For instance, the user may utilize WHATSAPP for file sharing but switching to LINKEDIN for professional discussions. The privacy is enhanced by allowing users to switch to a more private channel, like SIGNAL, for sensitive of confidential discussions. Communication is streamlined by eliminating the need to start a new conversation or switch between applications. Thus, communication is simplified, and productivity can be increased. In addition, other channels can be updated with the conversation changes to maintain records in each application if the users so desire.

As a non-limiting example, during a group conversation, User A may need or desire to share a confidential document with User B. Besides splitting the OTP using the splitter and validator as part of the UCP, the users switch from FACEBOOK to SIGNAL, leveraging its end-to-end encryption, and share the document securely. The conversation continues uninterrupted, with both/all users aware of the channel change. Later, the user switches back to FACEBOOK to share a related news article, demonstrating the flexibility and adaptability of UCP's dynamic channel switching feature.

Use Case—Promoting Communication Channels from Different Communication Modalities Such as Audio of a Specific Channel and Switch to Video from a Different Channel Identity for the Same User and Continue to See the History for that Conversation (this Also Plays a Significant Role in Compliance and Regulations)

One capability of the UCP is facilitating a unified communication history for compliance and regulatory purposes. In operation, the UCP stores all communication history, including messages, files, voice and video calls, and other interactions, in a secure and centralized repository. The repository could be distributed across the server or the edge or any of the combinations based on business use cases. This ensures that users can access their complete communication history, regardless of the channel or device used.

More particularly, the UCP synchronizes communication history across all channels, including social media platforms, messaging apps, and voice and video calling platforms. As such, as non-limiting examples, messages sent on FACEBOOK are also visible on WHATSAPP and other connected channels. Also, files shared on LINKEDIN are accessible on SIGNAL and other connected channels. Further, voice and video call history is synchronized across all channels.

In addition, the UCP synchronizes communication history across multiple devices, including:
Desktop computers;
Laptops;
Mobile phones;
Tablets;
Smart TVs & Kiosks; and
IOT devices, which would have an underlying presentation layer as well as other devices not listed.

Advantageously, this aspect of various embodiments of the UCP enables users to have access to their complete communication history, regardless of the device that they used over the course of the history.

The various embodiments of the UCP may operate to store communication history in a secure, encrypted, and compliant storage solution, ensuring that user data is protected from unauthorized access. Such storage solutions may be designed to meet the highest security standards, including:
End-to-end encryption;
Multi-factor authentication;
Regular security updates and patches; and
Compliance with major data protection regulations; and other standards.

As a more detailed but non-limiting example, the following tables illustrate some of these afore-mentioned aspects that may be included in various embodiments of the UCP.

Assume that User A is registered on the channels that are listed in Table 1 below as a non-limiting example, and also onboarded on the UCP.

TABLE 1
Registered on Channel

FACEBOOK
LINKEDIN
SIGNAL
Movius Web App desktop
Movius Mobile App (Android and iOS)

Also, assume that User A has access to utilize the following devices listed in Table 2, as a non-limiting example, for carrying out communications for User A.

TABLE 2
User A Devices

Desktop computer running Windows
Laptop computer (Mac)
Mobile telephone (Andriod)
Tablet (iPad running iOS)

In operation, the UCP may record the communication history presented in Table 3, as a non-limiting example.

TABLE 3
Communication History

| | | Message/ |
|---|---|---|
| Event | Channel | Description |
| User A sends a message to User B | FACEBOOK | Hey, let's meet up |
| | | for coffee? |
| User A shares file with User B | LINKEDIN | Q2 Sales Report.pdf |
| User A voice call to User C | WHATSAPP | 10-minute call |
| User A sends a message to User D | SIGNAL | Hi, how's it going? |
| User A receives a message from | MOVIUS Web | Let's schedule a |
| User E | App (Desktop) | meeting for next |
| | | week |

In performing the synchronization process available in any of the various embodiments, the UCP may operate to perform the synchronizations presented in Table 4, as a non-limited example.

TABLE 4
Synchronized History

| | | Message/ | |
|---|---|---|---|
| Event | Channel | Description | Synchron. On |
| User A sends a | FACEBOOK | Hey, let's meet | WHATSAPP, |
| message to User B | | up for coffee? | LINKEDIN, |
| | | | and Movius |
| | | | Web App |
| | | | (desktop) |
| User A shares file | LINKEDIN | Q2 Sales | Movius Web |
| with User B | | Report.pdf | App (desktop) |
| | | | and Movius |
| | | | App (Android |
| | | | and iOS) |
| User A voice call to | WHATSAPP | 10-minute call | Movius Web |
| User C | | | App (desktop) |
| | | | and Movius |
| | | | App (Android |
| | | | and iOS) |
| User A sends a | SIGNAL | Hi, how's it | Movius Web |
| message to User D | | going? | App (desktop) |
| | | | and Movius |
| | | | App (Android |
| | | | and iOS) |
| User A receives a | MOVIUS | Let's schedule a | FACEBOOK, |
| message from User E | Web App | meeting for next | WHATSAPP, |
| | (Desktop) | week | LINKEDIN |
| | | | and Movius |
| | | | App (Android |
| | | | and iOS) |

As a result of the operations provided by the UCP, User A can access the complete communication history, including messages, files, voice and video calls, and other interactions, from any device and any channel. For instance, as non-limiting examples, User A can:
view the conversation with User B on FACEBOOK, WHATSAPP, or Movius Web App (desktop) or Mobile App (Android and iOS);
access the file shared with User B on LINKEDIN, Movius Web App (desktop), or Mobile App (Android and iOS);
review User A's voice call with User C on WHATSAPP, Movius Web App (desktop), or Movius Mobile App (Android and iOS);
read message from User D on SIGNAL, Movius Web App (desktop), or Mobile App (Android and iOS); and
respond to User E's message on Movius Web App (desktop), FACEBOOK, WHATSAPP, or Movius Mobile App (Android and iOS).

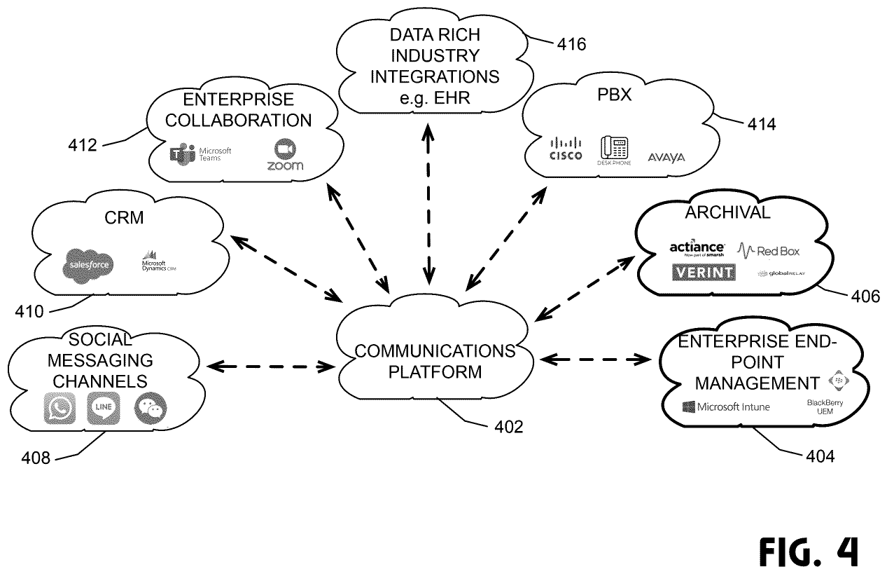

FIG. 4 is a functional diagram illustrating the telecommunications integration goal of various embodiments of the present invention. The listing of various communication sources, sinks, participants, etc., should not be viewed as comprehensive but rather as illustrative of the versatility of the various embodiments.

At the core of the integrated telecommunications illustrated in FIG. 4 (the UCP or communications platform 402) is the traditional voice and SMS (short message service) or MMS (Multimedia Messaging Service). However, in addition to those two fundamental channels of communication (reference 402), the disruption of the various embodiments of the present invention may also bring together, from left to right:
(1) Multiple social messaging channels 408, such as WHATSAPP, WECHAT, LINE (as non-limiting examples) all tied to this single unique number and without needing separate application interfaces OR separate identifiers;
(2) CRM cloud 410 illustrates the extension of the ability to receive or send calls and messages (include SMS, MMS, Social Messaging) within a multitude of CRM (Customer Relationship Management) systems without needing separate phone numbers or identities;
(3) Enterprise collaboration cloud 412 illustrates the extension of the ability for the users to be able to use the same phone number or identity within Unified Communication solutions (like MS Teams or Zoom or Cisco Webex or others) such that users can now spend their time productively without switching interfaces to connect with different people in their preferred ecosystems;
(4) PBX cloud 414 illustrates the seamless integration with PBX (Private Branch Exchange) systems eliminating the need for multiple phone numbers and multiple islands of communication (Fixed vs. Mobile); and
(5) Last but certainly not the least, security is preserved at each endpoint, at each interface and at each interaction with seamless integrations into Enterprise Mobility Management Solutions —404.

All of these above-described interactions can then be seamlessly integrated and ingested contextually and tied to that single unique identifier into the applicable System of Records systems like: Electronic Health Records (EHR) systems in health care 416; and a multitude of archival platforms used in several commercial and defense systems 406.

If we take a step back, and envision this disruption, this single number (identity) traversing multiple disparate communication islands and technologies would become the holy grail of simplification (as opposed to increasing the complexity), unification (as opposed to fragmentation), data amalgamation (as opposed to data silos), accessibility of information (as opposed to context switching from technology to technology) and bringing the notion of the identity tied to a position in a business not a specific individual, and that identity can be transferred seamlessly (people change, positions remain). All of this is achieved without creating a telecommunication standard or network specific solution.

The communications platform 402 is illustrated as being the central agent for enabling cross-communication among various sources, sinks, participants and technologies. The communications platform 402 may be an artificial intelligence (AI) powered, purpose driven, secure communications platform. The communications platform 402 can operate in a personal domain, an enterprise or business domain, or a hybrid of the two. Within the personal domain, the communications platform 402 seamlessly integrates the communications activity of a user including activities such as social media posts, social messaging channels, calendar activities, household management activities such as notifications from connected houses (i.e., ALEXA, SIRI, GO GOOGLE, SAMSUNG SMART THINGS, etc.), family schedules, school notifications, etc.

Within the business domain, the communications platform 402 seamlessly integrates into enterprise workflows and SaaS apps.

A workflow is a system for managing repetitive processes and tasks which occur in a particular order. They are the mechanism by which people and enterprises accomplish their work, whether manufacturing a product, providing a service, processing information or any other value-generating activity.

Within business process management, a workflow can be defined as a simple series of individual tasks, while a business process is considered more complex, consisting of multiple workflows, information systems, data, people and their activity patterns. A workflow is distinguished by its simplicity and repeatability, and it is generally visualized with diagram or checklist.

Workflow management software assists in simplifying and optimizing a business process within an organization. It largely does this by coordinating interactions among different stakeholders or between individuals and information systems. Workflow management systems route tasks to the appropriate employee at the right time, providing the pertinent information and nudge to expedite work along the overall process. It also supports manual and automated tasks through document management for activities, like expense reports.

SaaS (Software As A Service) is a form of cloud computing in which the provider offers the use of application software to a client and manages all the physical and software resources used by the application. The distinguishing feature of SaaS compared to other software delivery models is that it separates the possession and ownership of software from its use.

As such, the communications platform 402 operates to tie in a wide variety of business activities that operate in the realm of workflows and SaaS. For instance, one such activity includes enterprise end-point management 404. Examples of this activity include Microsoft Intune, which is a cloud-based unified endpoint management service for both corporate and “bring your own device” BYOD equipment. It extends some of the “on-premises” functionality of Microsoft Endpoint Configuration Manager to the Microsoft Azure cloud. Another example includes the BlackBerry UEM, which delivers complete, unified endpoint management and policy control for a company's diverse and growing fleet of devices and apps. The BlackBerry UEM includes a single management console and trusted end-to-end security model. The BlackBerry UEM is designed to help increase the productivity of a company's mobile workforce while ensuring the full protection of the company's business data.

The communications platform 402 also facilitates archive integration 406. The communications platform 402 enables cloud-based recording of communications and data. The communications platform 102 enables the cloud-based recording to be accessed by any EUD and thus, provides compliance, gap-free recording of messages regardless of the location of the EUD. This capability also allows the EUD to transfer recorded communications and data to preferred archival solutions for long-term retention and to have a level of confidence in the securement, retention and accuracy of recorded communications and messaging data. Advantageously, this capability simplifies the supervision, analysis, reporting and eDiscovery of the communications and data. Recordings, files, message streams, etc. can be automatically uploaded to any archival solution from any EUD utilizing the communications platform. Archival solutions may include DUBBER, VERINT, GLOBAL RELAY, VERBA, NICE, SOTERIA, REDBOX, ACTIANCE, AND SPLUNK, as non-limiting examples.

The communications platform 402 also facilitates the consolidation of business mobile messaging channels 408. Messages can be exchanged with consumers on multiple platforms, texting and social messaging, including WHATSAPP, WECHAT, and LINE etc. in a seamless and integrated manner. Advantageously, EUD can thus communicate with any customer over any of the messaging channels without requiring the customer to adapt to the messaging channel of the EUD and, also giving the EUD the freedom to utilize a preferred messaging channel. Further, this aspect of the communications platform 102, regardless of if the EUD is an enterprise device or a BYOD, provides more ways in which clients can keep in touch, maintains professionalism by enabling messaging using official business accounts, and avoids the hassle, expense and time waste of utilizing multiple EUDs.

It should be appreciated that the communications platform 402 also facilitates a cross-blend or combination of the various integrations. For instance, consolidating mobile messaging channels 408 also is integrated with the recordation of messages and the archiving of the same 406. Message recording includes messages, picture messaging, group messaging, and automated messages, such as opt-ins. For instance, an opt-in asks for and captures consent send messages from your business. Opt-in and texting disclaimers can be generated and delivered according to local requirements. In addition, redaction, the action of automatically preventing prohibited terms or information from being shared over messages or stored in your archives can also be integrated across the various channels and EUDs.

Along the same lines, many companies still employ the utilization of PBX systems for inter and extra company communications. This is especially true for work forces that do not have to be on the go but rather are able to be positioned at their stations, desks or offices. The communications platform 402 facilitates the consolidation of business messaging and communication channels through the use of PBX systems 414. Thus, state of the art PBX systems such as CISCO and AVAYA, as non-limiting examples, are seamlessly integrated by means of the communications platform 402.

Advantageously, the communications platform 402 provides seamless mobility in the personal and business domains. In the business domain, users can send messages from their desktop phones, desktop computers, MICROSOFT TEAMS, SALESFORCE CRM, etc. Thus, the employees can message at their desk or on the go with mobile EUDs. Employees can efficiently send messages utilizing their computer keyboard by using Desktop or Microsoft Teams integrations.

It can thus be appreciated that the communications platform 402 also greatly facilitates seamlessly integrating CRM activities 410. CRM is typically used to refer to customer relationship management software that provides the ability to track each interaction that employees have with prospects or customers. This interaction can include activities such as sales calls, customer service interactions, marketing emails, strategic brainstorming among colleagues, and more. CRM tools can unify customer and company data from many sources and even use AI (artificial intelligence) to help better manage relationships across the entire customer lifecycle, spanning departments like marketing, sales, digital commerce, and customer service interactions. The communications platform 102 thus seamless integrates a variety of commercially available CRM systems such as SALESFORCE, MICROSOFT DYNAMICS 365, HUBSPOT, PIPEDRIVE, MONDAY SALES CRM, etc. Thus, regardless of the EUD utilized for CRM, embodiments of the communications platform 402 may enable the data to be accessible to any other EUD.

An ever-increasing focus in today's workplace stems around the phrase “enterprise collaboration”. Enterprise collaboration is the process of helping diverse employees engage in teamwork across borders such that remote and local workers can participate in day-to-day tasks like file sharing, project management, and social media, all through one cohesive online system. With the influx of technology companies trying to create and market the “perfect enterprise collaboration” system, companies have acquired and adopted several solutions such as MICROSOFT TEAMS, SKYPE, ZOOM, etc. Another advantage of the communications platform 402 is the ability to seamlessly integrate various enterprise collaboration systems 412.

In addition to all the above, there are many additional industries that are classified as “data rich” industries, meaning that their day-to-day operations generate, collect, store, and depend on large amounts of data. Typically, this data needs to be reliably stored, securely protected and easily accessible by authorized EUDs. Advantageously, the embodiments of the communications platform 402 seamlessly integrate data rich industries 416, such as Electronic Health Records (EHR) in the health industry, banking and securities, media and entertainment, pharma and healthcare, education, manufacturing, insurance, transportation, government, energy and utilities, and retail and wholesale as non-limiting examples.

It should be understood by anyone in the industry, mobile messaging is a reality of doing business and it is going to be around for a long time. As such, it is imperative that companies give their employees a way to do business, easily and compliantly. The embodiments of the present invention provide technical solutions and platforms in which one or more of the afore-described advantages and aspects can be achieved.

The various embodiments of the communications platform provide the afore-described seamless integration through the use of a single number. In general, in one embodiment, each EUD that is serviced by the communications platform 102 is associated with a single unique number. That number is used in connection with all forms of communication with that EUD and the unique numbers can be tracked on behalf of various entities. For instance, on a personal level, a user may utilize 10 EUDs for various communication needs. The unique numbers associated with these EUDs all result in causing the telecommunications infrastructure to forward control of all such communications for these EUDs to the communications platform 402. At the communications platform 402, all these 10 unique numbers associated with the users 10 EUDs can be all tied together as being related to the same user. As such, the communications platform 402 can seamlessly integrate all communications associated with these EUDs.

In other embodiments, the EUDs owned or utilized by a particular entity may all include an identification number associated with that entity. As such, all communications that utilize that unique identification number can be seamlessly integrated by the communications platform 402.

In yet other embodiments, each of the EUDs may include unique identification numbers and the communications platform 402 can include various rules and categorizations to associate various unique identification numbers with various entities. For instance, Table 5 illustrates how a communications platform 402 could associate various unique identification numbers with various entities.

TABLE 5

| | | | | Associated |
|---|---|---|---|---|
| | | Associated | Associated | with User |
| Unique ID | | with User | with User | A and B's |
| Number | EUD | A personal | B personal | employer |
| UIDN0001 | User A's BYOD | Yes | No | Yes |
| | phone | | | |
| UIDN0002 | User B's BYOD | No | Yes | Yes |
| | phone | | | |
| UIDN0003 | User A's ZOOM | Yes | No | Yes |
| | account | | | |
| UIDN0004 | User A's | Yes | No | No |
| | FACEBOOK | | | |
| | acct | | | |

In this simplified example, the communications platform 402 associates User A's BYOD phone, User B's BYOD phone and User A's ZOOM account with the employer of User A and User B. In addition, User A's BYOD phone, User A's ZOOM account and User A's FACEBOOK account are all associated with User A personally. Likewise, User B's BYOD phone is personally associated with User B.

As such, in some embodiments, all EUDs associated with a user or an entity may utilize the same unique ID for that user or entity or, each EUD may have a unique ID and the communications platform 402 can associate one or more of the unique IDs with various users and/or entities. In the former case, communications associated with EUDs and identified by the unique IDs may also include further information to identify the identity of the type of EUD so that the communications platform can process the data appropriately (i.e., translate a FACEBOOK messenger such that it can be received by a WHATSAPP app).

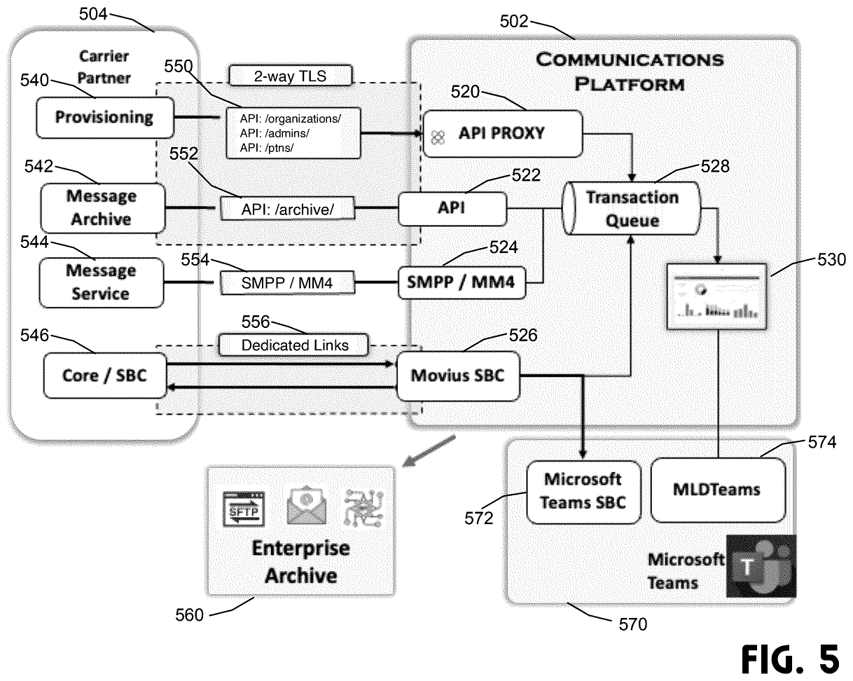

FIG. 5 is a functional block diagram illustrating the operation of an exemplary communications platform interacting with a carrier partner providing certain integrated communication services. The exemplary communications platform 502 is illustrated as interfacing with a carrier partner 504. It should be appreciated that the carrier partner 504 can be any participating carrier, such as brand name mobile provides (i.e., T-MOBILE) as well as small tier equipment lessees that also provide wireless service or any other communications or technology company that may be equipped to receive communication requests initiated by EUDs. Further, it should be understood, that while one carrier partner is illustrated in FIG. 5 multiple carrier partners may exist simultaneously and interface to the communications platform 502.

Initially the Carrier Partner 504 provisions the EUDs that are slated to receive or that are subscribed to the communications integration services provided through various embodiments of the present invention. As such, the Carrier Partner 504 operates initially to provision customers, admins, and lines. The Carrier Partner 504 provides the provisioning of the customers, admins, and lines by employment of a provisioning function 540 by the Carrier Partner 504 that interfaces with an API (Application Protocol Interface) proxy 520 provided by the communications platform 502 over one or more 2-way TLS communication channels.

TLS or Transport layer security is a cryptographic protocol that provides end-to-end security of data sent between applications over the Internet. TLS evolved from secure socket layers (SSL), which NETSCAPE COMMUNICATIONS CORPORATION developed in 1994 to secure web sessions.

TLS is normally implemented on top of transmission control protocol (TCP) in order to encrypt application layer protocols such as HTTP, file transfer protocol (FTP), simple mail transfer protocol (SMTP) and internet message application protocol (IMAP), although it can also be implemented on user datagram protocol (UDP), datagram congestion control protocol (DCCP) and stream control transmission protocol (SCTP), as well.

The Carrier Partner 504 operates to provision for the integrated communications service provided through the communications platform 502 for any form of EUD that is leveraging the service. In essence, during the provisioning process, the Carrier Partner 504 receives a unique identifier that is associated with the EUD. The Carrier Partner 504 then associates that unique identifier with that particular EUD and tags the EUD and unique identifier as being serviced by the communications platform 502. As a result of the provisioning, any and all forms of communication that are directed through the Carrier Partner 504 and that include the unique ID, are captured by the Carrier Partner 504 and routed to the communications platform 502. Thus, any communications technology that the communications platform is servicing, such as calls, messages, delivery to CRM, video conferences, etc., are captured by the Carrier Partner 504 and once the unique identifier is recognized, the communications are routed to the communications platform 502. In the illustrated example, the provisioning by the Carrier Partner 504 can be accomplished by invoking one or more particular API proxy functions, such as the three listed in proxy function block 550, namely API: /organizations/, API: /admins/, and API: /ptns/.

One of the features or operations of the communications platform 502 is the provision and/or orchestration of archival services. The archival services can be provided by the communications platform 502 as messages or communications are received from the Carrier Partner 504 or directly by the communications platform 502. For communications received by the communications platform 502, the communications platform 502 may store them directly into enterprise archive 560 or may send them to a message archive 542 function provided by the Carrier Partner 504. For communications received by the Carrier Partner 504, the Carrier Partner 504 can either provide them to the communications platform 502 for storage within the enterprise archive 560 by means of an API call 552 (i.e., API: /archive/) to the API 522 of the communications platform 502. Alternatively, the Carrier Partner 504 may transmit the messages to be archived to the communications platform 502 by means of an SMPP transmission 554, 524. Further, rather than sending messages to storage by the communications platform 502, the Carrier Partner 504 may archive the messages directly and simply forward notification of the same to the communications platform 502. Further, the Carrier Partner 504 may utilize a distributed archival system that can be accessed by other carrier partners and/or the communications platform 502. Further, in some embodiments, the Carrier Partner 504 and the communications platform 502 may maintained duplicate and redundant archives of all communications.

As previously described, one of the functions or features of the communications platform 502 is the ability to provide seamless integration of a wide variety of EUDs, and ultimately to be able to provide seamless integration to all EUDs. This is a very powerful and dynamic feature of the communications platform. In essence, the communications platform can be viewed as the communications unifier overcoming the inability to communicate across diverse channels and languages (or communication techniques protocols, etc.). This capability is provided through the communications platform 502, and in some circumstances with cooperation from the Carrier Partner 504. For instance, the communications platform 502 may directly receive, process and direct communications between EUDs, or may receive communications directed to the communications platform 502 from the Carrier Partner 504. In this latter scenario, a message service 544 of the Carrier Partner 504 receives messages that include the unique ID, then then invokes transmission or forwards of the same to the communications platform by issuing an SMPP or MM4 transfer 554 through and SMPP/MM4 interface 524 of the communications platform 502. Likewise, the core/SBC function 546 of the Carrier Partner 504 can receive calls that are associated with the unique ID and then forward the calls to the communications platform 502 via dedicated links 556 between the Carrier Partner 504 and the SBC interface 526 of the communications platform 502. The dedicated links 556 enable communications to be exchanged securely and reliably between the Carrier Partner 504 and the communications platform 502 with minimal latency.

An SBC (or session border controller) is a network element deployed to protect Session Initiation Protocol (SIP) based communications occurring over the Internet Protocol, such as voice over Internet Protocol (VoIP) as a non-limiting example. Early deployments of SBCs were focused on the borders between two service provider networks in a peering environment. This role has now expanded to include significant deployments between a service provider's access network and a backbone network to provide service to residential and/or enterprise customers.

The term “session” refers to a communication between two or more parties—in the context of telephony, this would be a call. Each call consists of one or more call signaling message exchanges that control the call, and one or more call media streams which carry the call's audio, video, or other data along with information of call statistics and quality. Together, these streams make up a session. It is the job of a session border controller to exert influence over the data flows of sessions.

The term “border” refers to a point of demarcation between one part of a network and another. As a simple example, at the edge of a corporate network, a firewall demarcates the local network (inside the corporation) from the rest of the Internet (outside the corporation). A more complex example is that of a large corporation where different departments have security needs for each location and perhaps for each kind of data. In this case, filtering routers or other network elements are used to control the flow of data streams. It is the job of a session border controller to assist policy administrators in managing the flow of session data across these borders.

The term “controller” refers to the influence that session border controllers have on the data streams that comprise sessions, as they traverse borders between one part of a network and another. Additionally, session border controllers often provide measurement, access control, and data conversion facilities for the calls they control.

SBCs commonly maintain full session state and offer the functions such as:
security to protect the network and other devices from malicious attacks (i.e. denial of service), toll fraud via rogue media streams, malformed packet protection, and encryption of signaling and media;
connectivity to allow different parts of the network to communicate through the use of a variety of techniques including NAT traversal, SIP normalization via SIP message and header manipulation, IPv4 to IPv6 interworking, VPN connectivity and Protocol translations between SIP, SIP-I, H.323;
quality of service (QoS) policy of a network and prioritization of flows including traffic policing, resource allocation, rate limiting, call admission control, and ToS/DSCP bit setting;
regulatory support such as emergency call prioritization and lawful interception;
media services though built-in digital signal processors (DSPs) to enable them to offer border-based media control and services such as DTMF relay and interworking, media transcoding, tones and announcements, data and fax interworking, support for voice and video calls; and
statistics and billing information because all sessions that pass through the edge of the network pass through the SBC, it is a natural point to gather statistics and usage-based information on these sessions.

SBCs are inserted into the signaling and/or media paths between calling and called parties (eg. Within a VoIP call), predominantly those using the Session Initiation Protocol (SIP), H.323, and MGCP call-signaling protocols.

In many cases the SBC hides the network topology and protects the service provider or enterprise packet networks. The SBC terminates an inbound call and initiates the second call leg to the destination party. The effect of this behavior is that not only the signaling traffic, but also the media traffic (voice, video) is controlled by the SBC. In cases where the SBC does not have the capability to provide media services, SBCs are also able to redirect media traffic to a different element elsewhere in the network, for recording, generation of music-on-hold, or other media-related purposes. Conversely, without an SBC, the media traffic travels directly between the endpoints, without the in-network call signaling elements having control over their path.

In other cases, the SBC simply modifies the stream of call control (signaling) data involved in each call, perhaps limiting the kinds of calls that can be conducted, changing the codec choices, and so on. Ultimately, SBCs allow the network operators to manage the calls that are made on their networks, fix or change protocols and protocol syntax to achieve interoperability, and also overcome some of the problems that firewalls and network address translators (NATs) present for VoIP calls.

To show the operation of an SBC, one can compare a simple call establishment sequence with a call establishment sequence with an SBC. In the simplest session establishment sequence with only one proxy between the user agents the proxy's task is to identify the callee's location and forward the request to it. The proxy also adds a Via header with its own address to indicate the path that the response should traverse. The proxy does not change any dialog identification information present in the message such as the tag in the From header, the Call-Id or the Cseq. Proxies also do not alter any information in the SIP message bodies. Note that during the session initiation phase the user agents exchange SIP messages with the SDP bodies that include addresses at which the agents expect the media traffic. After successfully finishing the session initiation phase the user agents can exchange the media traffic directly between each other without the involvement of the proxy.

SBCs are designed for many applications and are used by operators and enterprises to achieve a variety of goals. Even the same SBC implementation might act differently depending on its configuration and the use case. Hence, it is not easily possible to describe an exact SBC behavior that would apply to all SBC implementations. In general, it is possible to identify certain features that are common to SBCs. For example, most SBCs are implemented as back-to-back user agent. A proxy-like server can split an SIP transaction in two call legs: on the side facing the user agent client (UAC), it acts as server, on the side facing user agent server (UAS) it acts as a client. While a proxy usually keeps only state information related to active transactions, it may keep state information about active dialogs, e.g., calls. That is, once a proxy receives a SIP request it will save some state information. Once the transaction is over, e.g., after receiving a response, the state information will soon after be deleted. The state information may be maintained for active calls and only deleted once the call is terminated.

When an SBC is included in the call path, the SBC operates as a user agent server towards the caller and as user agent client towards the callee. In this sense, the SBC actually terminates that call that was generated by the caller and starts a new call towards the callee. The INVITE message sent by the SBC no longer may contain a clear reference to the caller. The INVITE sent by the SBC to the proxy includes Via and Contact headers that point to the SBC itself and not the caller. SBCs often also manipulate the dialog identification information listed in the Call-Id and From tag. Further, in case the SBC is configured to also control the media traffic then the SBC also changes the media addressing information included in the c and m lines of the SDP body. Thereby, not only will all SIP messages traverse the SBC but also all audio and video packets. As the INVITE sent by the SBC establishes a new dialog, the SBC also manipulates the message sequence number (CSeq) as well the Max-Forwards value. Note that the list of header manipulations listed here is only a subset of the possible changes that an SBC might introduce to a SIP message. Furthermore, some SBCs might not do all of the listed manipulations. If the SBC is not expected to control the media traffic then there might be no need to change anything in the SDP body. Some SBCs do not change the dialog identification information and others might even not change the addressing information.

SBCs are often used by corporations along with firewalls and intrusion prevention systems (IPS) to enable calls (eg., VoIP calls) to and from a protected enterprise network. Call service providers use SBCs to allow the use of particular protocols from private networks with Internet connections using NAT, and also to implement strong security measures that are necessary to maintain a high quality of service. SBCs also replace the function of application-level gateways. In larger enterprises, SBCs can also be used in conjunction with SIP trunks to provide call control and make routing/policy decisions on how calls are routed through the LAN/WAN. There are often tremendous cost savings associated with routing traffic through the internal IP networks of an enterprise, rather than routing calls through a traditional circuit-switched phone network.

Additionally, some SBCs can allow calls to be set up between two phones using different signaling protocols (e.g., SIP, H.323, Megaco/MGCP) as well as performing transcoding of the media stream when different codecs are in use. Most SBCs also provide firewall features for call traffic (denial of service protection, call filtering, bandwidth management). Protocol normalization and header manipulation is also commonly provided by SBCs, enabling communication between different vendors and networks.

In the illustrated example of FIG. 5, the communications platform 502 is shown as interfacing with Microsoft Teams 570. It will be appreciated that the exemplary architecture and interface with any of a wide variety of applications and/or EUDs such as Microsoft Teams and the use of Microsoft Teams is simply provided as an example. The communications platform 502 interfaces to a Microsoft Teams SBC 572 for voice and/or video content while messages and data can be provided through an MLDTeams application 574. Messages received from the Carrier Partner 504 are placed into a transaction queue 528 and the content 530 can then be transferred to Microsoft Teams 570 via the MLDTeams interface 574.

The architecture illustrated in FIG. 5 also enables FCC compliance, Legal Intercept Compliance, and Emergency Communications Compliance.

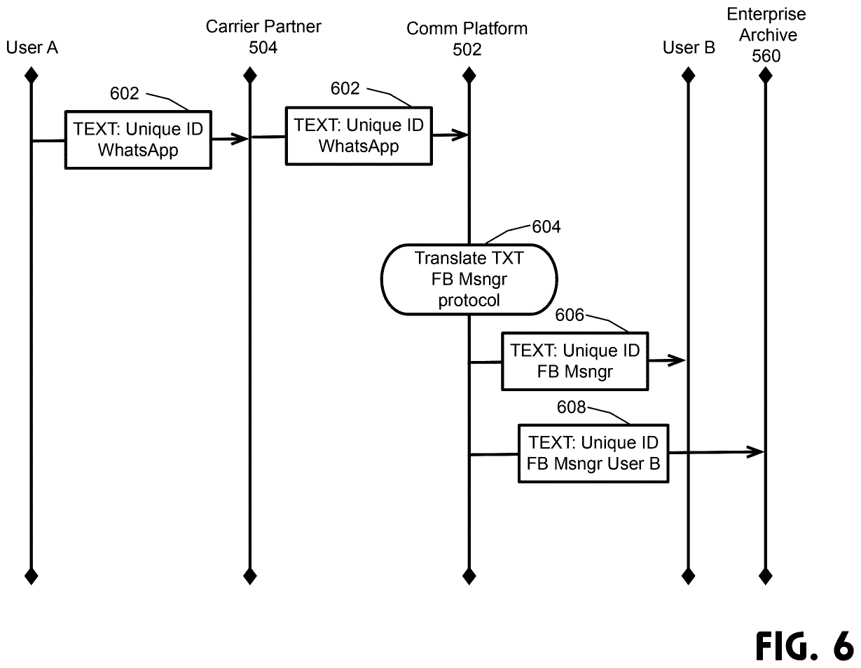

A few practical examples of the operation of the architecture illustrated in FIG. 5 are presented. FIG. 6 is a flow diagram illustrating a first communication exchange example based on an exemplary architecture such as that illustrated in FIG. 5 as a non-limiting example. In this example, assume that User A utilizes WHATSAPP to talk with User B who uses FB Messenger and that User B is utilizing an EUD that subscribes to the integrated communications service provide by the communications platform 502. Initially, User A sends a text 602 to User B, the text includes the destination of User B. The Carrier Partner 504 sees the User B destination and determines that it is to be processed by the communications platform 502. As such, the Carrier Partner 504 forwards the message 602 to communications platform 502. The communications platform then identifies the destination of the message and determines that the message is directed to a particular EUD with a particular unique ID and that has a preference known to the communications platform 502 of using FACEBOOK MESSENGER for exchanging of texts messages. The communications platform 502 then performs a protocol translation of the message from WHATSAPP to FACEBOOK MESSENGER 604 and forwards the message to the intended destination 606—User B. The communications platform 502 may also record the message into the Enterprise Archive 560 for User B in FACEBOOK MESSENGER format 608 tied to the unique ID.

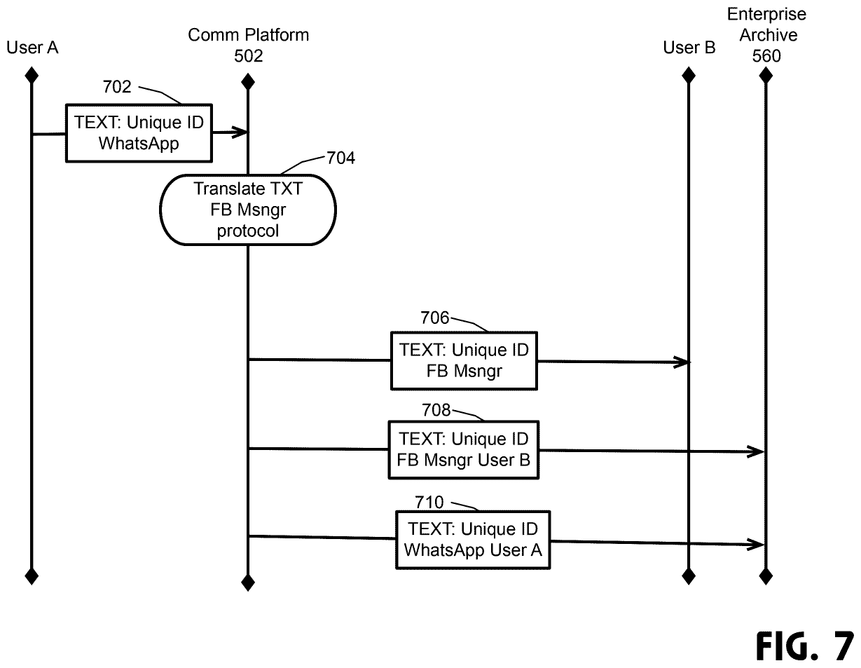

FIG. 7 is a flow diagram illustrating a communication exchange example based on an exemplary architecture such as that illustrated in FIG. 5. In this example, assume that User A utilizes WhatsApp to talk with User B who uses FB Messenger and that both User A and User B are utilizing EUDs that subscribe to the integrated communications service provide by the communications platform 502. Initially, User A sends a text 702 to User B, the text includes the unique ID of User A and the destination of User B. The text 702 is received by the communications platform 502. The communications platform 502 then identifies the destination of the message and determines that the message is directed to a particular EUD what has a preference of using FACEBOOK MESSENGER for exchanging of texts messages. The communications platform 502 then performs a protocol translation of the message from WHATSAPP to FACEBOOK MESSENGER 404 and forwards the message to the intended destination 706—User B using the unique ID of User B. Communications platform 502 may employ the multiline/multichannel technology presented in U.S. Pat. Nos. 11,563,711 and/or 9,332,128 (both of which are incorporated herein above by reference) in sending the communications between User A and User B. The communications platform 502 may also record the message into the Enterprise Archive 560 for User B in FACEBOOK MESSENGER format 708 and User A in WHATSAPP format 710.

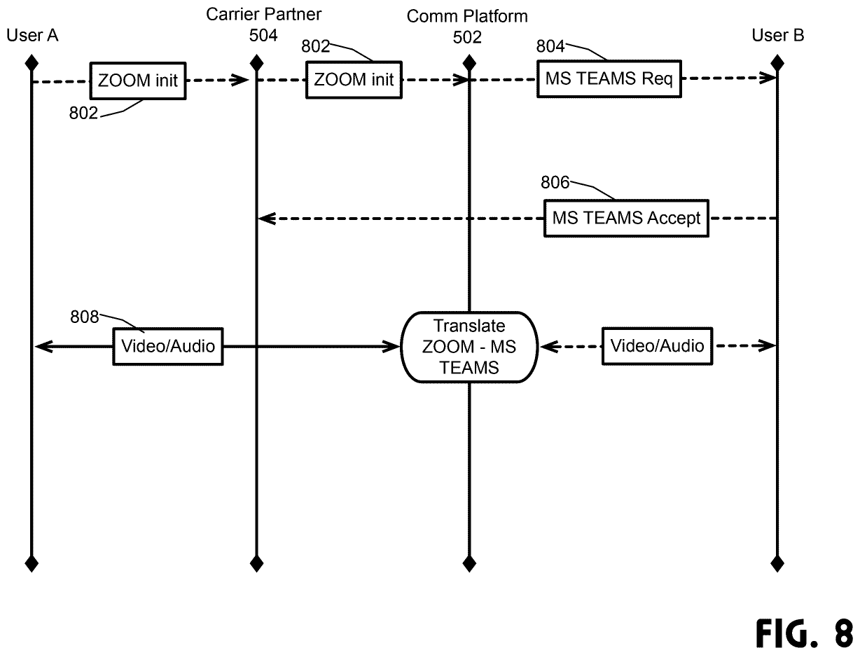

FIG. 8 is a flow diagram illustrating another communication exchange example based on an exemplary architecture such as that illustrated in FIG. 5. User A and User B enter a video conference with User A using ZOOM and User B using MICROSOFT TEAMS. The video conference is initially set up with User A initiating the conference with User B 802. During the setup process, the Carrier Partner 504 detects the unique ID of User A in setting up the conference call and forwards the setup request to the communication platform 502 to be processed. The communication platform 502 recognizes the unique ID for User A and the unique ID of User B and thus identifies both as subscribers to the service. The communication platform 502 then identifies that User B prefers MICROSOFT TEAMS and that User A prefers to use ZOOM. The communications platform 502 then sends an MS TEAMS request 804 to User B. Upon receiving an MS TEAMS accept 806 from User B the communication platform 502 completes the video call connection between User A and User B. Video and Audio between User A and the communication platform is in the ZOOM format and between the communication platform 502 and User B is in MICROSOFT TEAMS format 810. The communication platform 502 performs the translations as well as providing translations for messages transmitted between the two users, archived deposits, etc.

Thus, it should be appreciated that call or message communication happens through a carrier powered endpoint (mobile phone, tablet, connected device) and then that call arrives to the communication platform with a single unique identity. With that single unique identity, the communication platform can do several things using the multiline/multichannel technology presented in U.S. Pat. No. 9,332,128 for delivery to different end points (CRM, ZOOM, TEAMS, Messaging systems) and also to get the carrier to terminate as needed and appropriate.

What is important to various embodiments of the present invention is the provision of the single unique identifier from the EUD to invoke the provision of the integrated communication services by the communication platform. The single unique identifier is provided in various manners dependent upon the technology or protocol being employed during the communication setup. In general, it will be understood that the integrated communication services can be accessed by any EUD that is provisioned to operate over a carrier network or, any application or system that operates on such an EUD. As those skilled in the art will understand, a carrier provisioned EUD will include a Subscriber Identity Module (“SIM”) card or an Embedded Subscriber Identity Module (“ESIM”). The SIM card or ESIM is provisioned by the carrier and is unique to the EUD. When the EUD is utilized to set up a communication, such as placing a call, sending a text, sending and SMS, MMS, establishing a video conference, etc., the EUD must first transmit a setup request and that request will include the single unique identifier associated with the EUD or user of the EUD. The single unique identifier may be provisioned to the EUD by the operator of the communication platform or may be provisioned by the carrier in response to the operator of the EUD requesting such provisioning.

Under each of the cellular protocols, during a call setup request, the EUD transmits identifying information as to the originating party or unit. This is most typically in the form of calling line identifier (“CLID”); however, it should be appreciated that many protocols include additional space above and beyond just space in the protocol for the 10-digit phone number associated with the initiating device. As such, during a typical call setup, the EUD may provide the mobile identification number (“MIN”), unique SIM information, the network number that the EUD is provisioned with, as well as additional unique identification information. This information is provisioned into the EUD device by a carrier partner when the user is subscribing to the integrated communication services. This single unique identification number is provided to the carrier operator during all communication set up initiations and, the carrier operator receives the single unique identification number and forwards the communication setup request to the communications platform for processing as described above.

Certain actions or blocks in the processes or process flows described in this specification naturally precede others for the embodiment to function as described. However, the various embodiments are not limited to the order of the actions or blocks as presented or described. That is, it is recognized that some actions or blocks may be performed before, after, or in parallel (substantially simultaneously with) other actions or blocks without departing from the scope and spirit of the various embodiments. In some embodiments, certain actions or blocks may be omitted or not performed as not all embodiments necessarily must implement all of the described actions. Also, in some embodiments, multiple actions depicted and described as unique actions or blocks in the present disclosure may be comprised within a single step or block. Further, words such as “thereafter”, “then”, “next”, “subsequently”, etc. are not intended to limit the order of the actions or blocks. These words are simply used to guide the reader through the description of the exemplary method.

Additionally, one of ordinary skill in programming will be able to write computer code or identify appropriate hardware and/or circuits to implement the various embodiments, as well as features and aspects thereof, based on the flow charts and associated description in this specification. Therefore, disclosure of a particular set of program code instructions or detailed hardware devices is not considered necessary for an adequate understanding of how to make and use the various embodiments. The functionality of the claimed computer implemented processes is explained in more detail in the above description and in conjunction with the Figures that may illustrate various process flows.

Based on all of the above, as those of ordinary skill in the art would understand, under existing traditional technology the network services and identifiers have remained siloed and network specific, they were not unique across ecosystems. The uniqueness e of various embodiments of the present invention utilize a single identifier (an MSISDN, a SIM, an ESIM, or a uniquely asserted self-sovereign identity) to now bring all channels of communication and fragmented technologies together. Similar to the reversal of the Tower of Babel or, the user of a Babel Fish in the ear as presented in Hitch Hikers Guide to the Galaxy.

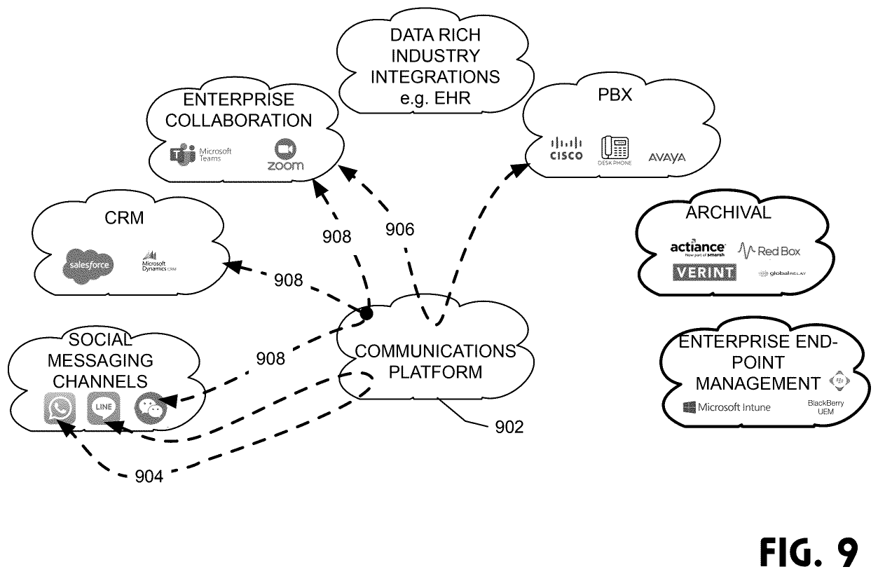

FIG. 9 is a sky of clouds illustrating the overall operation of an embodiment of an exemplary communications platform 902. The communications platform operates as the Babel Fish and enables communication between all of the various platforms, technologies, communications channels, terminal devices, communication applications, etc. A single unique identity is provided for each user, or each position, etc. This single unique identity is what the communications platform 902 utilizes to recognize a communications initiator and a communications recipient.

The communications platform 902 is shown as effectively operating in the middle of a complex orchestration of communication. A few scenarios are illustrated in FIG. 9. For instance, communication session 904 is between a first EUD using the WHATSAPP application and another EUD using the LINE messaging app. In this scenario, assume the communication was initiated by the user of the WHATSAPP application. That user initiates a connection to the user of the LINE messaging app. The communications platform 902 receives the communication initiation, either directly or as being recognized by the communications infrastructure (i.e. PSTN, MTN, etc), and recognizes the unique identification of the initiating EUD. The communications platform 902 also recognizes the destination and the unique identifier associated with the destination EUD. The communications platform 902 thus knows that the initiating EUD is communicating with the WHATSAPP application and the receiving EUD is communicating with the LINE messaging application. The communications platform 902 can perform any necessary translations on the communication between the two EUDs and store a history of the communications session into the archives for both EUDs.

As another example, communication session 906 is between an initiating EUD utilizing a ZOOM connection and receiving EUD utilizing a PBX connection. The communications platform 902 receives the communication initiation from the initiating EUD and recognizes the unique identifier associated therewith. The communications platform 902 also recognizes the unique identifier of the receiving EUD. The communications platform 902 operates as a bridge to enable these two disparate communications technologies to actually be engaged in a communications session. The communications platform 902 receives voice communications from the ZOOM app and converts it as necessary to send to the PBX and vice versa. The communications platform 902 is aware that the PBX cannot provide video or process video and as such, simply obtains and provides the voice communications from the ZOOM app. The communications platform 902 can also provide an indicator that the receiving EUD is not video capable by providing such information as a ZOOM avatar for the receiving EUD.

As another example, communication session 908 illustrates a one-to-many communications session established by a messaging app EUD with a MICROSOFT TEAMS EUD and a MICROSOFT DYNAMICS CRM EUD. Similarly, the communications platform recognizes the unique identifiers, identifies a language or protocol that can 1 be spoken to each EUD and coordinates the communication session.

Thus, it should be appreciated that the communications platform 902, utilizing the single unique identifiers for each EUD, can establish a communications session between any technology and breaks down the silos imposed by current state of the art technology.

### Headless Communications Archival for Multichannel Communications Across Devices

A large user base that is operating within various enterprises is restricted from installing applications, features and functionality on their corporate issued and managed devices. This is a disadvantage for such users in that they may not be able to set up a work environment that they are used to, that provides them efficiency, that enables the access to tools that they have integrated into their working environment, etc. The solution offered by industry is to allow such users to operate as BYOD users. However, enterprises are then at risk because they cannot capture and archive communications that transpire using such BYOD equipment. It should be appreciated by those skilled in the art that there is a strong need for enterprises to capture and archive such communications for regulation, compliance and seamless operation (i.e., when an employee leaves and takes know-how with them).

The various embodiments of the present invention provide a native capture of Multichannel Communication (NCMC) across devices and thus provides a solution to capture voice calls, messaging, and telemetry from the telco core network for all its approved subscribers and the subscriber devices. Advantageously, the various embodiments are able to provide the NCMC operation without requiring the subscribers or the enterprise to install any agents or applications on the subscriber devices.

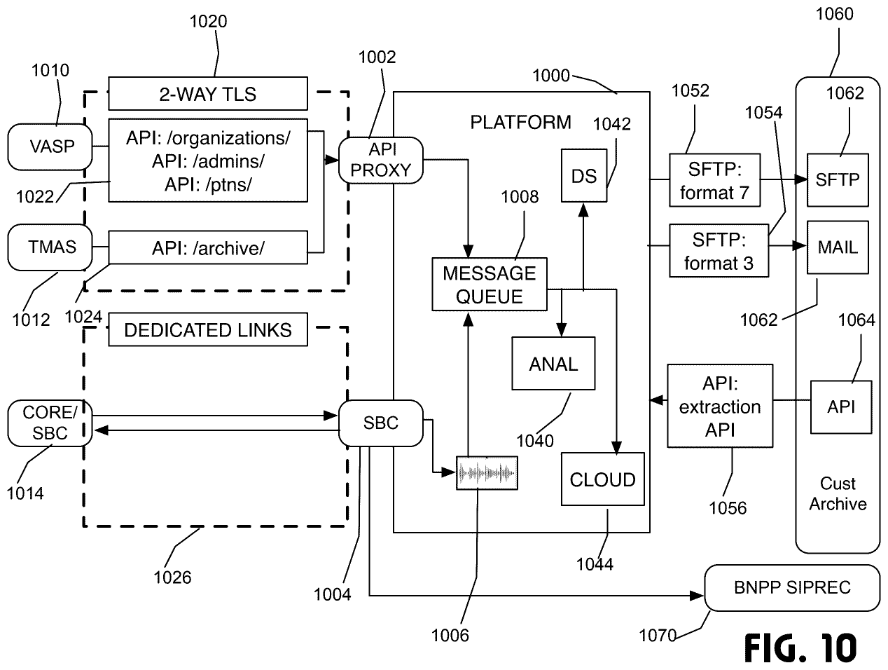

FIG. 10 is a block diagram illustrating the basic operations of an exemplary embodiment providing NCMC across devices. In general, the data gets ingested from the telco core network in either of the modes—push and pull either through APIs or SDKs. As this is primarily a passive ingestion from the core network there are many workflows which would involve interjecting into an ongoing conversation for workflows such as involving disclaimers, readouts before entering into a workflow for regulatory adherence.

Some underlying components which are part of NCMC would include:
Provisioning APIs;
Archive APIs;
Calling Interfaces; and
Multi-media Messaging Interfaces.

For provisioning APIs, a Telco Integrator uses an Integrated Reseller API to provision new enterprises, admins and numbers. Once the number is provisioned on the platform 1000, messages and calls can be recorded.

Archiving APIs involves the Telco Integrator sending message payloads a message archive API endpoint. The message is sent asynchronously and does not impact message deliver. The platform generates call data records and digital safe records for reconciliation.

The calling interfaces utilize the Telco Integrator to route calls for corporate liable (CL) subscribers toward the NCMC. The NCMC anchors the media and passes the call back to the Telco Integrator. The NCMC then generates call data records and recordings on the platform 1000 or via the SIPREC to the enterprise.

The multi-media messaging interfaces offered via multiline services leverages the ability to interconnect with the Telco Integrator messaging structure. As such, SMS message flow through the Telco Integrator SMSCs and MMS messages flow through the Telco Integrator MMSCs.

The various embodiments of the present invention provide key differentiators from the state of the art by providing several capabilities. For instance, the various embodiments provide out-of-band disclaimers and workflows with the user in a conversation. Another differentiator is the provision of in-band disclaimers and workflows with users in a conversation. The various embodiments provide keyword spotting and can also trigger workflows. Further, the various embodiment can generate outbound messages and sync up from the NCMC to other outbound channels.

In-band disclaimers essentially mean a system injecting messages into the message thread. Out-of-band disclaimers is how the various embodiments of the UCP notify the participants on a separate thread that their message thread is being monitored or disclaimers related to the conversations.

The various embodiments of the NCMC can provide in-band and out-of-band disclaimers and workflows with users that are in a conversation. Generally, if an entity issues work phone (company liable) (CL), the entity has complete access to the communications and the apps installed on the CL and the operation thereof. This includes communication in the form of calls, text, SMS, MMS, social media messaging, etc. If a user has a CL device and the user and entity have a relationship and have a conversation, in the midst of the call the entity can simply say “this is being recorded”. When sending an SMS message, there is no disclaimer that is going to the parties. SMS there will be an out-of-band message that indicates it is a recorded line.

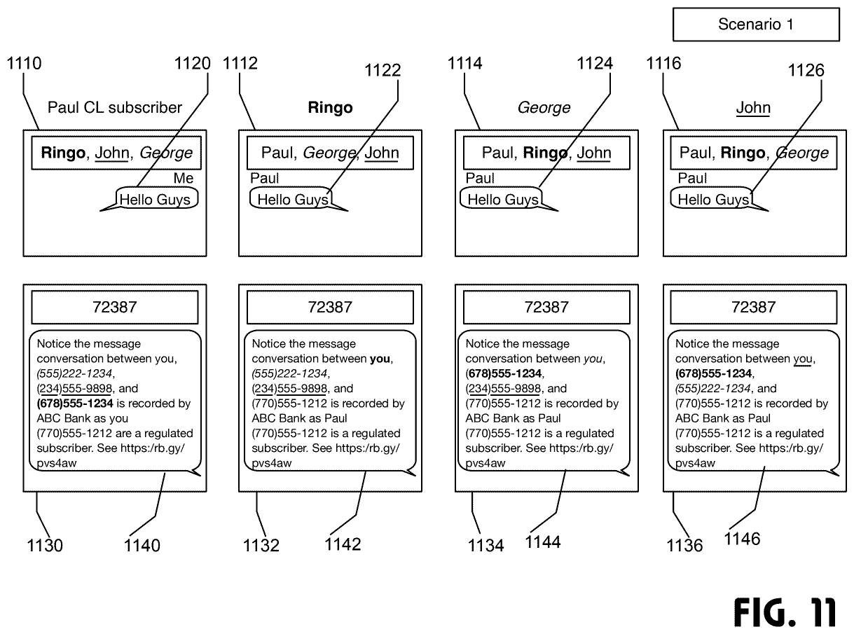

FIG. 11 is a block diagram illustrating scenario 1—providing out-of-band disclaimers for a message that is initially provided from a CL subscriber. The conversation illustrated in FIG. 11 is between Paul (a CL subscriber with number (770) 555-1212), and Ringo (number (678) 555-1234), George (number (555) 222-1234) and John (number (234) 555-9998) that are not CL subscribers. Note that Paul and his number are in regular font, Ringo and his number are bolded, George and his number is in italics and John and his number are underlined simply for illustrative purposes to help identify who is associated with what number.

In the illustrated example, Paul initiates the conversation with Ringo, George and John in block 1110 by sending “Hello Guys” 1120 to all three of them in a group conversation. The message shows up in Paul's message box 1110 as being sent by Paul (Me) and it shows up in the message boxes of Ringo 1112 as message 1122, George 1114 as message 1124, and John 1116 as message 1126 as being originated by Paul. Because this scenario reflects the provision of an out-of-band disclaimer, the disclaimer is provided to the participants of the conversation as a separate message (i.e., send from 72387) and the disclaimer provides notice of the participants of the conversation and that the conversation is being recorded by ABC Bank as Paul is a regulated subscriber. As such, disclaimer 1140 appears in Paul's message box 1130, disclaimer 1142 appears in Ringo's message box 1132, disclaimer 1144 appears in George's message box 1134 and disclaimer 1146 appears in John's message box 1134. When an SMS/MMS message is sent from an app on a device (native app or third-party app on the device, mobile originated (MO) message flows through multiple networks at the telco network layer before it is received at the receiver device/app and mobile terminated (MT). In the end-to-end flow, when the USP in the platform is involved before it is delivered at the MT, the in-band scenario arises. When an SMS/MMS message is sent from an app on a device (native app or third-party app on the device), the mobile originated (MO), the message besides flowing through multiple networks is also captured as part of the TMAS—message archival. When the messages are exposed to the UCP in platform only through the TMAS and when the platform or UCP is not in the flow of the messages from MO to MT devices, this is the situation of being out-of-band.

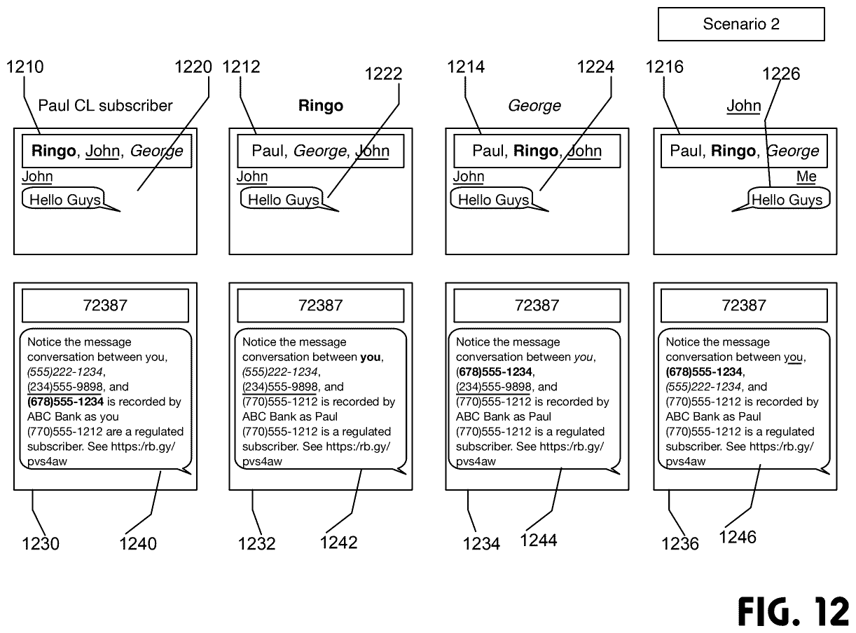

FIG. 12 is a block diagram illustrating scenario 2, providing out-of-band disclaimers for a message that is initially provided from a non-CL subscriber. The conversation illustrated in FIG. 12 is between Paul (a CL subscriber), and Ringo, George and John that are not CL subscribers. In the illustrated example, John initiates the conversation with Ringo, George and Paul in block 1216 by sending “Hello Guys” 1226 to all three of them in a group conversation. The message shows up in John's message box as being sent by John (Me) and it shows up in the message box of Paul 1210 as message 1220, Ringo 1212 as message 1222, and George 1224 as message 1224 as being originated by John. Because this scenario reflects the provision of an out-of-band disclaimer, the disclaimer is provided to the participants of the conversation as a separate message (i.e., send from 72387) and the disclaimer provides notice of the participants of the conversation and that the conversation is being recorded by ABC Bank as Paul, a member of the conversation, is a regulated subscriber. As such, disclaimer 1240 appears in Paul's message box 1230, disclaimer 1242 appears in Ringo's message box 1232, disclaimer 1244 appears in George's message box 1234 and disclaimer 1246 appears in John's message box 1234.

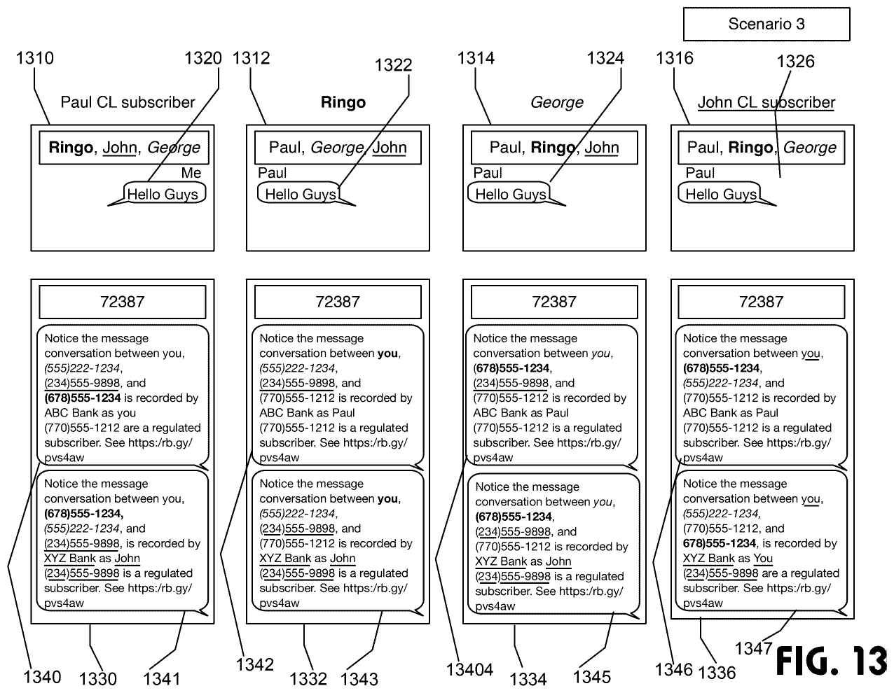

FIG. 13 is a block diagram illustrating scenario 3—providing out-of-band disclaimers for a message that is initially provided from Paul (a CL subscriber) and involves John (another CL subscriber). The conversation illustrated in FIG. 13 is between Paul (a CL subscriber), and Ringo, George and John (another CL subscriber). In the illustrated example, Paul initiates the conversation with Ringo, George and John in block 1310 by sending “Hello Guys” 1320 to all three of them in a group conversation. The message shows up in Paul's message box as being sent by Paul (Me) and it shows up in the message box of Ringo 1322, George 1324, and John 1326 as being originated by Paul. Because this scenario reflects the provision of an out-of-band disclaimer, the disclaimer is provided to the participants of the conversation as a separate message (i.e., send from 72387) and the disclaimer provides notice of the participants of the conversation and that the conversation is being recorded by ABC Bank as Paul is a regulated subscriber. However, because John is also a CL subscriber, a second disclaimer is also sent out-of-band to each of the participants to let them know that John is a regulated subscriber and that the conversation is being recorded by XYZ Bank. As such, disclaimers 1340 and 1341 appear in Paul's message box 1330, disclaimers 1342 and 1343 appear in Ringo's message box 1332, disclaimers 1344 and 1345 appear in George's message box 1334 and disclaimers 1346 and 1347 appear in John's message box 1334.

It should be appreciated that these first three scenarios, which are all out-of-band scenarios, provides disclaimers to the participants as application-to-person (“A2P”) messages. Application-to-Person messaging, is a mobile telecommunications practice where businesses use web-based apps to message individuals on their mobile phones. This streamlined process ensures effective communication and connectivity within the digital landscape.

There are multiple modes on how the UCP platform is or becomes aware of the messages flowing through the network. For instance, when the UCP is in the path of the telecom network's signaling and media flows, the UCP will be completely aware of everything being streamed on the network between the MO and MT devices/apps.

On the other hand, when the UCP is not in the path of the signaling and media flow for messages between the MO and MT devices/apps, the messages are captured and made available by the telecoms as part of the archival or capture path. Those services would be pushing the messages including metadata through the archival/capture path into UCP in various types such as webhooks, WebSockets, SMPP, MM4, MM3. This would be the streaming scenario in the archival/capture path.

Yet further, the UCP may not exist in the path of the signaling and media flow for messages between the MO and MT devices/apps. In this scenario the messages would be captured and made available by the telecoms as part of the archival or capture path. The UCP polls the messages captured including the metadata either through varied architectural variants such as RESTful API, GraphQL, gRPC, MQTT, WebSockets, webhooks, SMPP, MM4, MM3.

Businesses across different industries typically use automated A2P SMS to communicate with customers. The process begins with a dedicated App-to-Person messaging platform or software application, such as the UCP. The application on the UNC generates an SMS message when a specific event or trigger occurs. The message is then transmitted via an A2P SMS gateway to the mobile network operator (MNO). The MNO subsequently delivers the SMS to the recipient's mobile device. In the present scenarios, the NCMC detects the transmission of the message from Paul 1110. This can be accomplished by the message being detected at the API proxy and provided to the message queue 1008 of the platform (i.e. UCP) 1000. An analyzer 1006 can review the message, identify the source by detecting the originating number and recognizing the number as a CL subscriber number. This all takes place without any modification to the mobile devices utilized by the participants in the conversations as the platform 1000 is simply parasitically coupled to the telco system to detect and analyze the data.

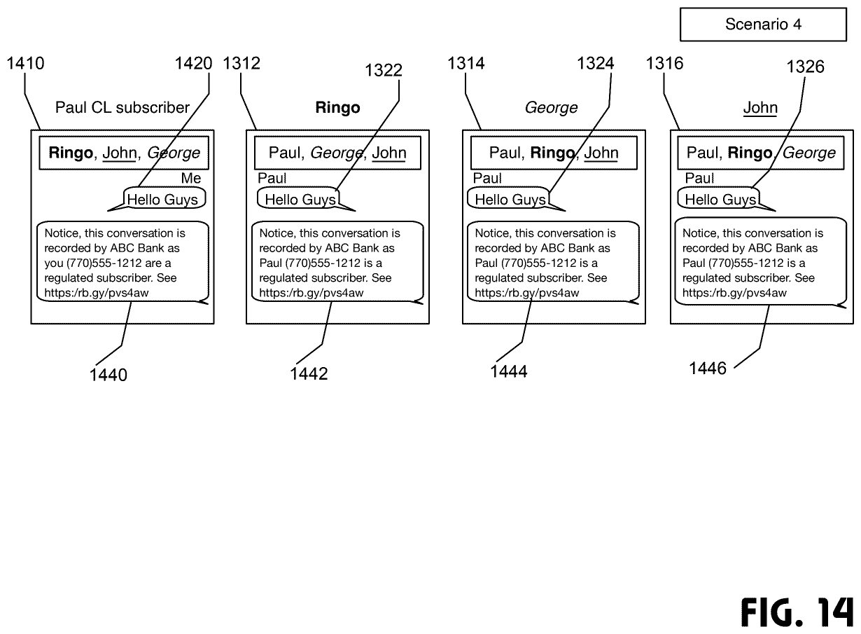

FIG. 14 is a block diagram illustrating scenario 4—providing in-band disclaimers for a message that is initially provided from Paul (a CL subscriber). The conversation illustrated in FIG. 14 is between Paul (a CL subscriber), and Ringo, George and John (all non-CL subscribers). In the illustrated example, Paul initiates the conversation with Ringo, George and John in block 1410 by sending “Hello Guys” 1420 to all three of them in a group conversation. The message shows up in Paul's message box as being sent by Paul (Me) and it shows up in the message boxes of Ringo 1412 as message 1422, George 1414 as message 1424, and John 1416 as message 1426, all as being originated by Paul. Because this scenario reflects the provision of an in-band disclaimer, the disclaimer is provided to the participants of the conversation directly in their respective message boxes 1410, 1412, 1414, and 1416. The disclaimer provides notice of the participants of the conversation and that the conversation is being recorded by ABC Bank as Paul is a regulated subscriber. As such, disclaimer 1440 appears in Paul's message box 1410, disclaimer 1442 appears in Ringo's message box 1412, disclaimer 1444 appears in George's message box 1414 and disclaimer 1446 appears in John's message box 1416.

Referring back to FIG. 10, the platform 1000 interfaces directly to the telecommunications system, such as the Public Switched Telephone Network (PSTN), Mobile Telephone Networks (MTN), as well as other networks such a Voice Over IP networks, etc. As such, telemetry can be received from value added service providers (“VASP”) at interface 1010 and delivered to API PROXY 1002 through a 2-way TLS 1020 and appropriate APIs 1022. It should be understood that value added services (VAS) refers to supplementary features provided by wireless carriers to enhance the functionality of mobile units for their subscribers. Non-limiting examples of VASs include emergency services (911), customer service (611), Caller ID, voicemail, SMS, four-digit dialing, telemetry, and information lines for traffic and sports. VASPs are providers that offer VAS in addition to standard voice calls and fax transmissions. In the system illustrated in FIG. 10, VASP 1010 plays a role in the activation of the different services at the carrier/provider and that information is passed onto the platform 1000 as part of the onboarding of subscribers to the service.

Similarly, telemetry and data can be received from message archival service at the telecom network level and provided to the API PROXY 1002 through the 2-way TLS 1020 an appropriate API 1024. The Telco Message Archival Service (TMAS) is exposed by the telecom network to enable the reception of messages from their archival systems. The various embodiments support both push and pull methods, where the system received streaming copies of messages which would be flowing through their network, as well as copies of messages which the telco would have stores as part of the archival modes in their network. The data exchange can happen across multiple architectural variants such as RESTFUL API, GRAPHQL, GRPC, MQTT, WEBSOCKETS, WBHOOKS, SMPP, MM4, MM3, etc. As such, these interfaces allow the platform 1000 to receive cellular data and other forms of data that take the form of SMS and MMS as well as other forms of messaging without being in the path of the transmissions but rather, to parasitically listen in on the transmissions and direct them towards the platform 1000. An alternative to using the TMAS may include other options such as short message service center (SMSC) or multimedia messaging service center (MMSC), which would be on the telecom network side and sending copies of the message/media through MM3 (MM3 is a 3GPP interface that connects an MMSC to external services such as the UCP) and MMR (MM4 is a protocol that allows different MMCS's to communicate with each other) protocols.

TLS, short for Transport Layer Security, and SSL short for Secure Socket Layers, are both cryptographic protocols that encrypt data and authenticate a connection when moving data on the Internet. For example, if you're processing credit card payments on your website, TLS and SSL can help you securely process that data so that malicious actors can't get their hands on it.

In one way SSL, only client validates the server to ensure that it receives data from the intended server. For implementing one-way SSL, server shares its public certificate with the clients.

Below is the high-level description of the steps involved in establishment of connection and transfer of data between a client and server in case of one-way SSL:

1. Client requests for some protected data from the server on HTTPS protocol. This initiates SSL/TLS handshake process.

2. Server returns its public certificate to the client along with server hello message.

3. Client validates/verifies the received certificate. Client verifies the certificate through certification authority (CA) for CA signed certificates.

4. SSL/TLS client sends the random byte string that enables both the client and the server to compute the secret key to be used for encrypting subsequent message data. The random byte string itself is encrypted with the server's public key.

5. After agreeing on this secret key, client and server communicate further for actual data transfer by encrypting/decrypting data using this key.

Contrary to one-way TSL; in case of two-way TSL, both client and server authenticate each other to ensure that both parties involved in the communication are trusted. Both parties share their public certificates to each other and then verification/validation is performed based on that.

Below is the high-level description of the steps involved in establishment of connection and transfer of data between a client and server in case of two-way TSL:

1. Client requests a protected resource over HTTPS protocol and the SSL/TSL handshake process begins.

2 Server returns its public certificate to the client along with server hello.

3. Client validates/verifies the received certificate. Client verifies the certificate through certification authority (CA) for CA signed certificates.

4. If Server certificate was validated successfully, client will provide its public certificate to the server.

5. Server validates/verifies the received certificate. Server verifies the certificate through certification authority (CA) for CA signed certificates.

6. After completion of handshake process, client and server communicate and transfer data with each other encrypted with the secret keys shared between the two during handshake.

Further, the core telecommunication system telemetry is also received by the CORE/SBC interface 1014 to be transmitted over dedicated links 1026 to the SBC interface 1004 to platform 1000. The audio telemetry received through the SBC 1004 is provided to a convertor 1006 which converts the signals into data and provides the message to the Message Queue 1008.

The messages in the Message Queue 1008 are analyzed in the data analyzer 1040 to identify the types of messages, the source of the messages, the destination of the messages and to look for trigger words that may trigger certain other processes for the messages. This information is then provided to a Data Store 1042 and the Cloud 1044. From the Data Store 1042 and/or Cloud 1044, this information is then packaged into an appropriate SFTP format, such as format 7 1050 or format 3 1052 and respectively provided to the SFTP storage 1062 or Mail storage 1064 of the Customer Archive 1060. Further, the messages may be extracted from the API 1064 of the Customer Archive 1060 through the Extraction API 1056.

In addition, the telemetry data from the SBC 1004 can also be directed to the BNPP SIPREC 1070. The Session Recording protocol, or SIPREC is standard that defines a protocol used to interact between a Session Recording Client (SRC) (the role played by the PBX system or the Session Edge Controller) and a Session Recording Server (SRS) (a third-party call recording solution).

The following illustration shows two endpoints—SIP users. The communication session is established through the recording device and the session is being recorded by an SRC and SRS. The session recording client has access to the media path between the users. The SRC then establishes the recording session with the SRS and sends replicated media to the SRS. The SRC is also responsible for delivering metadata to the SRS, such as participant information (phone number, the call, etc.) in XML format. The standard also allows the extension of sent metadata. Providers are free to send additional metadata attributes that are specific to their telephone system. For example, BroadWorks sends the values “service provider ID”, “group ID” and “user ID”. Metaswitch sends “Business Group Name” and other attributes.

It should be noted that an SRC is a logical function. Its capabilities can be implemented in a session border controller, a SIP media gateway, a SIP phone or a SIP media server integrated with an application server.

There are several benefits to customers when SIPREC is utilized. First of all the customers experience a lower acquisition cost. The cost of implementing a recording system based can be high, which requires a large capital investment and is generally beyond the reach of many companies. The implementation of SIPREC allows customers to achieve economies of scale with the consolidation of IT staff and hardware resources. In addition, there are no initial investments to the customer. The call recording service can be provided using the software model as a service (SaaS). Without administration or maintenance costs, the software is managed by the service provider.

The use of SIPREC also provides benefits for the service provider. For instance, a hosted call recording service offers a great opportunity to generate revenue for service providers, allowing them to reach new markets, attract new customers and expand their portfolio of solutions. Call recording is a critical and indispensable requirement in many business communications environments, such as call centers and companies in the financial sector. In some of these sectors, all calls must be registered for regulatory and compliance reasons. In others, calls can be recorded for quality control or business analysis. Service providers can gain a competitive advantage with cloud call recording solution.

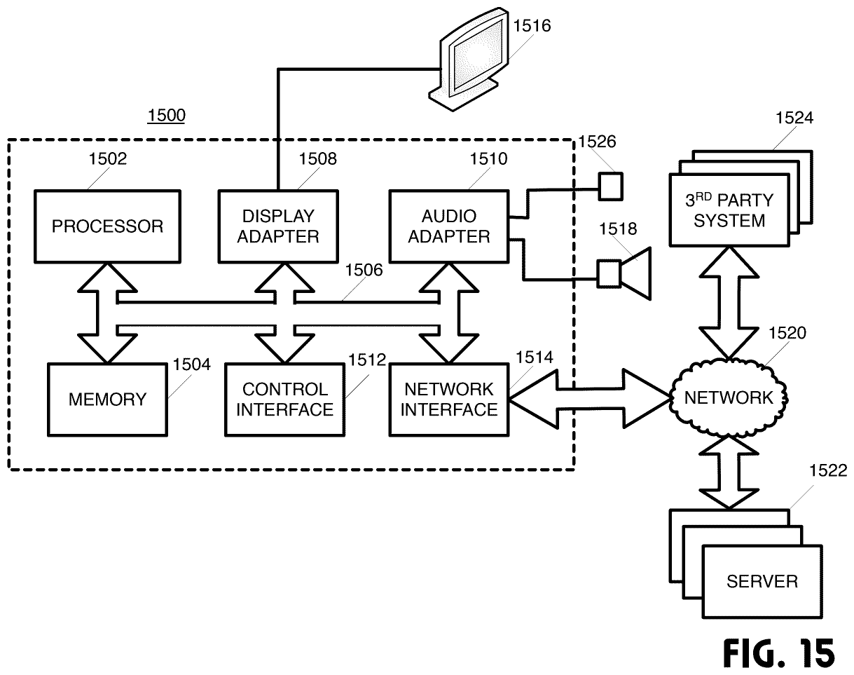

FIG. 15 is a functional block diagram of the components of an exemplary embodiment of system or sub-system operating as a controller or processor 1500 that could be used in various embodiments of the disclosure for controlling aspects of the various embodiments. It will be appreciated that not all of the components illustrated in FIG. 15 are required in all embodiments of the activity monitor but, each of the components are presented and described in conjunction with FIG. 15 to provide a complete and overall understanding of the components. The controller can include a general computing platform 1500 illustrated as including a processor/memory device 1502/1504 that may be integrated with each other or, communicatively connected over a bus or similar interface 1506. The processor 1502 can be a variety of processor types including microprocessors, micro-controllers, programmable arrays, custom IC's etc. and may also include single or multiple processors with or without accelerators or the like. The memory element of 1504 may include a variety of structures, including but not limited to RAM, ROM, magnetic media, optical media, bubble memory, FLASH memory, EPROM, EEPROM, etc. The processor 1502, or other components in the controller may also provide components such as a real-time clock, analog to digital convertors, digital to analog convertors, etc. The processor 1502 also interfaces to a variety of elements including a control interface 1512, a display adapter 1508, an audio adapter 1510, and network/device interface 1514. The control interface 1512 provides an interface to external controls, such as sensors, actuators, drawing heads, nozzles, cartridges, pressure actuators, leading mechanism, drums, step motors, a keyboard, a mouse, a pin pad, an audio activated device, as well as a variety of the many other available input and output devices or, another computer or processing device or the like. The display adapter 1508 can be used to drive a variety of alert elements 1516, such as display devices including an LED display, LCD display, one or more LEDs or other display devices. The audio adapter 1510 interfaces to and drives another alert element 1518, such as a speaker or speaker system, buzzer, bell, etc. The network/interface 1514 may interface to a network 1520 which may be any type of network including, but not limited to the Internet, a global network, a wide area network, a local area network, a wired network, a wireless network or any other network type including hybrids. Through the network 1520, or even directly, the controller 1500 can interface to other devices or computing platforms such as one or more servers 1522 and/or third-party systems 1524. A battery or power source provides power for the controller 1500. Therefore, although selected aspects have been illustrated and described in detail, it will be understood that various substitutions and alterations may be made therein without departing from the spirit and scope of the present invention, as defined by the following claims.

In one or more exemplary embodiments, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, acoustic and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

What is claimed is:

1. A system to enable multichannel communication across a variety of devices in a single group conversation, the system comprising:
a unified communication platform;
a plurality of interfaces, wherein each of the plurality of interfaces are communicatively coupled to the unified communication platform and are communicatively couplable to one or more user devices;
the unified communications platform includes a processing system that is configured to:
receive a communication request through a first interface from a first user device, wherein the communication request identifies one or more participating user devices for a communication session and a unique ID for the first user device, wherein the unique ID at least identifies a preferred communication channel for the first user device;
identify a preferred channel for each of the identified one or more participating user devices;
establishing a connection between the first user device and each of the one or more participating user devices to commence a group communications session;
receiving a conversation element from the first user device;
converting the received conversation element to a format compatible with each of the one or more participating user devices; and
delivering the converted conversation elements to one or more participating user devices;
whereby users from diverse channels are converged into a single group communications session.

2. The system of claim 1, wherein the unified communications platform is further configured to:
receive a channel change request from the first user device or any of the one or more participating user devices during the group communications session; and
without disrupting the group communications session, begin converting the received conversation elements in accordance with the channel change request.

3. The system of claim 1, wherein the unified communications platform is further configured to:
receive a channel change request from the first user device or any of the one or more participating user devices during the group communications session, wherein the channel change request is for a channel that is more applicable for file transfers; and
without disrupting the group communications session, begin converting the received conversation elements in accordance with the channel change request and enable file transfers for the requesting user device.

4. The system of claim 1, wherein the unified communications platform is further configured to:
receive a channel change request from the first user device or any of the one or more participating user devices during the group communications session, wherein the channel change request is for a channel that provides secure communications; and
without disrupting the group communications session, begin converting the received conversation elements in accordance with the channel change request.

5. The system of claim 1, wherein the preferred channel for each of the user devices is based on a preferred application that is being utilized to communicate by each of the user devices, and wherein the unified communications platform is further configured to:
receive a channel change request from the first user device or any of the one or more participating user devices during the group communications session, wherein the channel change request is provided by the requesting user switching to a different application; and
without disrupting the group communications session, begin converting the received conversation elements in accordance with the format required for the different application.

6. The system of claim 5, further comprising an interface to an archive for storing information, and wherein the unified communications platform is further configured to:
store each of the communications elements into the archive as a communications history.

7. The system of claim 6, wherein the unified communications platform is further configured to store each of the communications element into the archive as a communications history by storing one or more of text messages, files, voice calls, and video calls.

8. The system of claim 5, further comprising an interface to an archive for storing information, and wherein the unified communications platform is further configured to:
store each of the communications elements into the archive as a communications history, wherein the communication elements may include one or more of text messages, files, voice calls, and video calls; and
provide access to any of the user devices to access and review its respective communications history.

9. The system of claim 1, wherein the plurality of interfaces comprise:
a PBX interface for integrating telephone calls;
a social media messaging interface for integrating social media communications;
an enterprise interface for integrating video conferences; and
a customer relationship management (“CRM”) interface for integrating CRM systems.

10. The system of claim 1, wherein the unique ID is associated with any available communication channel.

11. A method for enabling multichannel communication across a variety of devices in a single group conversation, the method comprising the actions of:
providing a unified communication platform that includes a plurality of interfaces, wherein each of the plurality of interfaces are communicatively coupled to the unified communication platform and are communicatively couplable to one or more user devices;
the unified communication platform:
receiving a communication request through a first interface from a first user device, wherein the communication request identifies one or more participating user devices for a communication session and a unique ID for the first user device, wherein the unique ID at least identifies a preferred communication channel for the first user device;
identifying a preferred channel for each of the identified one or more participating user devices;
establishing a connection between the first user device and each of the one or more participating user devices to commence a group communications session;
receiving a conversation element from the first user device;
converting the received conversation element to a format compatible with each of the one or more participating user devices; and
delivering the converted conversation elements to one or more participating user devices;
whereby users from diverse channels are converged into a single group communications session.

12. The method of claim 11, wherein the method further comprises the actions of:
receiving a channel change request from the first user device or any of the one or more participating user devices during the group communications session; and
without disrupting the group communications session, converting the received conversation elements in accordance with the channel change request.

13. The method of claim 11, wherein the method further comprises the actions of:
receiving a channel change request from the first user device or any of the one or more participating user devices during the group communications session, wherein the channel change request is for a channel that is more applicable for file transfers; and
without disrupting the group communications session, converting the received conversation elements in accordance with the channel change request and enable file transfers for the requesting user device.

14. The method of claim 11, wherein the method further comprising the actions of:
receiving a channel change request from the first user device or any of the one or more participating user devices during the group communications session, wherein the channel change request is for a channel that provides secure communications; and
converting the received conversation elements in accordance with the channel change request without disrupting the group communications session.

15. The method of claim 11, wherein the preferred channel for each of the user devices is based on a preferred application that is being utilized to communicate by each of the user devices, and wherein the method further comprises:
receiving a channel change request from the first user device or any of the one or more participating user devices during the group communications session, wherein the channel change request is provided by the requesting user switching to a different application; and
converting the received conversation elements in accordance with the format required for the different application without disrupting the group communications session.

16. The method of claim 15, further comprising an interface to an archive for storing information, and wherein the method further comprises the action of storing each of the communications elements into the archive as a communications history.

17. The method of claim 16, wherein the unified communications platform is further configured to store each of the communications element into the archive as a communications history by storing one or more of text messages, files, voice calls, and video calls.

18. The method of claim 15, further comprising an interface to an archive for storing information, and wherein the method further comprises the actions of:
storing each of the communications elements into the archive as a communications history, wherein the communication elements may include one or more of text messages, files, voice calls, and video calls; and
providing access to any of the user devices to access and review its respective communications history.

19. The method of claim 11, wherein the plurality of interfaces comprise:
a PBX interface;
a social media messaging interface;
an enterprise interface; and
a customer relationship management (“CRM”) interface; and
the method further comprises integrating communication elements from each interface.

20. The method of claim 11, wherein the unique ID is associated with any available communication channel and the actions of receiving a communication request through a first interface and identifying a preferred channel for each of the identified one or more participating user devices further comprises selecting a communications channel that is associated with the unique ID.
